(19) United States
(12) Patent Application Publication
(10) Pub. No.: US 2024/0242099 A1
(43) Pub. Date: Jul. 18, 2024

(54) SYSTEMS AND METHODS FOR CONDUCTING SIMULATIONS WITH VIRTUAL HUMANS

(71) Applicant: Parham AARABI, Toronto (CA)

(72) Inventor: Parham AARABI, Toronto (CA)

(21) Appl. No.: 18/097,840

(22) Filed: Jan. 17, 2023

(51) Int. Cl. G06N 7/01; G06Q 30/0601

(52) U.S. Cl. CPC G06N 7/01; G06Q 30/0641

(57) ABSTRACT

Computer-implemented methods of using artificial intelligence (AI) to simulate user experiences with websites or applications can be used to improve the design and functions of computing systems supporting the platform for the website or application. The methods may involve one or more of the following: creating models of virtual users defined by parameters characterizing intent, identifying user options provided by the websites or applications, generating probabilistic networks defining transition dependencies between the identified options, and simulating the user experiences with websites or applications based on the user models.

### TECHNICAL FIELD

The present disclosure relates generally to artificial intelligence (AI), and in particular, to systems and methods for simulating input actions (e.g., keyboard events, keystrokes, mouse activity, etc.) on a user device using AI and virtual humans. Some embodiments have example applications for measuring and optimizing experiences provided by a user experience platform through a website or application to a user of the user device.

### BACKGROUND

Recent advancements in cloud computing, data analytics, and digital payment technology have led to rapid growth in areas like online shopping and e-commerce. By leveraging existing features provided by e-commerce platforms or other web development services, individual sellers and business are now able to set up their own websites or applications with relative ease.

However, there is currently no practical way to measure the effectiveness of a website, application, or platform prior to implementation. Currently, the only way to test the effectiveness of such pre-launch websites or applications is to rely on feedback from human users that have been hired to conduct the testing prior to implementation. Such testing usually requires a fully built website or application, can involve high costs, and can be susceptible to human errors. In addition, even with sufficient human user testing, it is oftentimes difficult to identify changes that need to be made to improve user experience.

There remains a need for systems and computer-implemented methods for simulating the interactions between users (e.g., shoppers) and various computing systems providing an application to the users. There remains a need for methods of simulating user experiences with websites or applications (e.g., an e-commerce website) to improve the design and features of the user experience. There remains a need for simulation systems that can help provide insight on the efficacy of experiences provided through the websites or applications of e-commerce platforms.

### SUMMARY OF THE DISCLOSURE

The following embodiments and aspects thereof are described and illustrated in conjunction with systems and methods which are meant to be exemplary and illustrative, not limiting in scope. In various embodiments, one or more of the above-described problems have been reduced or eliminated, while other embodiments are directed to other improvements.

One aspect of the invention relates to a computer-implemented method for simulating interactions between a human user and an application (e.g., an e-commerce application, or the like). The method includes the steps of creating a model of a virtual user, performing a simulation of the virtual user's experience, measuring statistically relevant information, and reporting the statistically relevant information. The model of the virtual user is defined by user intent parameters, with each user intent parameter representing an intention of the virtual user to perform a corresponding action in the application. The simulation of the virtual user's experience is performed by executing a sequence of actions in the application based on values assigned to the user intent parameters. The statistically relevant information that are measured typically includes one or more of: conversion rate, sales rate, and cart rate. The results of the simulation may be recorded. The recorded results may be analyzed to identify a percentage of successful outcomes in the simulation.

In some embodiments, the user intent parameters are assigned values in accordance with a probabilistic network. The probabilistic network may model a probability of specific actions at multiple points of the virtual user's experience with the application. In some embodiments, the user intent parameters comprise an exit probability corresponding to the virtual user's intention to leave the experience. In some embodiments, the user intent parameters comprise a modified intention probability adjusted for the experience's emotional impact on the virtual user.

In some embodiments, the virtual user model is designed to account for progression in time of the virtual user as the virtual user navigates through different parts of the application. In some embodiments, options of the virtual user's experience on the application are modeled using a probabilistic network. The probabilistic network may comprise one or more of a Markov chain, a Markov network, and a Markov random field.

Other aspects of the invention relate to a computer-implemented method for simulating a user experience on an application (e.g., an e-commerce application). The method begins with the identification of user options provided by the application and the generation or setup of a probabilistic network. The probabilistic network has nodes corresponding to the identified options and edges defining transition dependencies between the identified options. Transition probabilities are assigned to the edges of the probabilistic network based on details of the identified options, and action step(s) are associated with the nodes of the probabilistic network. Based on the transition probabilities and the action steps, the probabilistic network is traversed to simulate the user experience on the application.

In some embodiments, the probabilistic network is traversed through repeatedly. In such embodiments, the aggregate simulation performance results may be measured and recorded. In some embodiments, the transition probabilities are updated dynamically during the traversal through the probabilistic network. In some embodiments, the probabilistic network is a three-dimensional Markov network. In such embodiments, edges connecting nodes in first and second dimensions may correspond to dependencies between user options in a first page of the application, and edges connecting nodes in the third dimension with nodes in the first or second dimensions may correspond to dependencies between user options across multiple pages of the application.

In some embodiments, the details of the identified options include one or more of: option visibility, option prominence, and emotional context associated with the option. In some embodiments, the action steps include one or both of adding a product to cart and completing a checkout. In some embodiments, the assignment of transition probabilities to the edges of the probabilistic network involves conducting multiversal training in accordance with methods described herein.

Other aspects of the invention relate to a computer-implemented method for conducting multiversal training of a machine learning system. The method includes the steps of obtaining an intended demographic focus for the machine learning system, obtaining demographic information for training data elements, and training the machine learning system. The training is performed based on weighting the plurality of training data elements based on the demographic information and the intended demographic focus.

Other aspects relate to a system to perform one or more of the methods described herein. The system may comprise a processor configured to generate a model of a virtual user, perform a simulation of the virtual user's experience in a user application, measure statistically relevant information, and report the statistically relevant information. The model of the virtual user is defined by user intent parameters, with each user intent parameter representing an intention of the virtual user to perform a corresponding action in the application. The simulation of the virtual user's experience is performed by the processor causing a sequence of actions to be executed in the application based on values assigned to the user intent parameters. The statistically relevant information that are measured typically includes one or more of: conversion rate, sales rate, and cart rate. The results of the simulation may be recorded and stored in a data storage or memory accessible to the processor. The recorded results may be analyzed by the processor to identify a percentage of successful outcomes in the simulation.

In addition to the exemplary aspects and embodiments described above, further aspects and embodiments will become apparent by reference to the drawings and by study of the following detailed descriptions.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. Features and advantages of the embodiments of the present invention will become apparent from the following detailed description, taken in with reference to the appended drawings in which:

FIG. 1 is block diagram of a method for simulating the interactions between a user device and an e-commerce application according to an example embodiment.

FIG. 2 is a block diagram illustrating the steps performed during the simulation block shown in FIG. 1.

FIGS. 3A to 3H illustrate various parameters used in a simplified demonstration of performing the FIG. 1 method in relation to an e-commerce platform.

FIGS. 4A to 4C depict the results of the simplified demonstrations conducted based on the parameters shown in FIGS. 3A to 3H.

FIG. 5 is a block diagram of an exemplary method for simulating the interactions between a user device and an e-commerce application using delta modeling.

FIG. 6 is a block diagram of a method for simulating user experiences in an e-commerce platform. FIGS. 6A to 6F illustrate exemplary graphic user interfaces (GUIs) of a system implementing the FIG. 6 method.

FIG. 7 is a block diagram of a method for analyzing a website according to an example embodiment. FIGS. 7A to 70 illustrate exemplary GUIs of a system implementing the FIG. 7 method.

FIG. 8 is a block diagram of a method for conducting comparative analysis according to an example embodiment. FIG. 8A is an exemplary table of results obtained from conducting the comparative analysis shown in FIG. 8.

FIGS. 9A to 9B illustrate exemplary Sankey diagrams of the virtual user simulation results for various e-commerce experiences. FIGS. 9C and 9D show custom step tagging and tracking for the virtual user simulation.

FIG. 10 shows an exemplary GUI of a system conducting multiversal analysis according to an example embodiment.

### DETAILED DESCRIPTION

The description which follows, and the embodiments described therein, are provided by way of illustration of examples of particular embodiments of the principles of the present invention. These examples are provided for the purposes of explanation, and not limitation, of those principles and of the invention.

Aspects of the invention relate to systems and computer-implemented methods for simulating the interactions between users and various computing systems providing an application to the users' devices. The simulations may be fully automated or conducted with human assistance. Results of the simulations may be used to improve the functions of computing systems and/or user experiences provided by the application.

Some embodiments have example applications for simulating the interactions between users' devices (e.g., a phone, a tablet, a personal computer, etc.) and backend systems (e.g., a server) providing a web application or an e-commerce application or platform to the users of the devices. In such embodiments, the method may involve the execution of multiple simulations of artificial intelligence (AI) driven shopper personas, each of which may exhibit different behaviors based on the training user base or pre-set user parameters. These AI-generated personas are then activated within an e-commerce and/or shopping simulation and their actions within the simulation experience are recorded. Examples of metrics that may be recorded include, but are not limited to, the length of time spent in the simulation, the e-commerce/shopping conversation rate, the e-commerce/shopping basket size, total sales per user, as well as other interaction metrics that could be relevant in an e-commerce/shopping experience. The simulation(s) can be repeated and the metrics can be re-evaluated based on changes to the e-commerce/shopping simulation, including changes to the e-commerce/shopping experience, addition of new features, changes to the load-time, changes to the visual images, or any other e-commerce/shopping experience changes.

For the purposes of facilitating the description, the terms “e-commerce” and “shopping” are used herein to refer to the purchasing of products or services via any website, or app, as well as any in-store shopping experience. Methods described herein may be used or otherwise applied to improve e-commerce systems, systems that provide applets such as email newsletters, banner ads, as well as any other systems that facilitate user interaction. In general, methods described herein may be applied to any user application (including any computer application or mobile application), web application, website, e-commerce application, or platform that provides a user experience (i.e., any user experience platform). The word “application” (as used herein) may be interpreted to refer to any of the above-noted applications or platforms for providing a user experience.

In addition, it should be noted that while the term e-commerce is used throughout the description, systems and methods described herein can be applied to any website or application that has an end goal (or a series of goals). Examples of such applications include: websites that have the goal of the user sharing information, booking an appointment, following a specific recipe, watching an ad or a video, or downloading a particular software. Consequently, the word “e-commerce” (as used herein) may be interpreted to also refer to a website, application, applet, experience, or interface that has one or more specific action goals, with one specific example being purchasing a product but with there being many other possible examples as noted above.

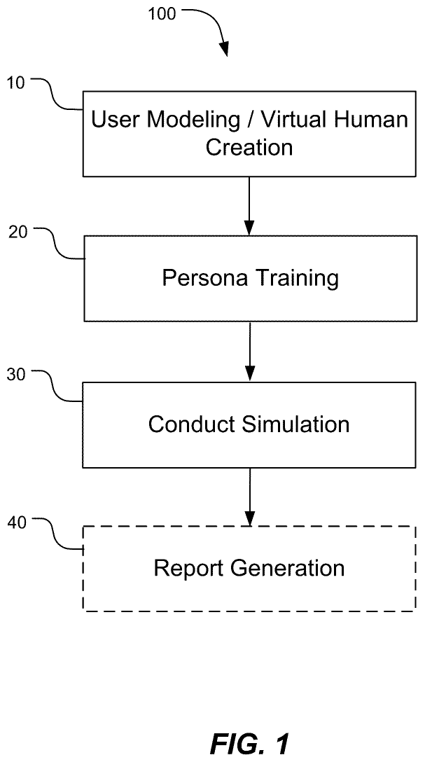

Referring now to FIG. 1, described herein is an exemplary method 100 to simulate the interactions between a user system and an e-commerce website or application. Method 100 may be used in some cases to simulate an in-store or online shopping experience. Method 100 comprises the steps of user modeling 10, persona training 20, and shopping simulation 30 as depicted in FIG. 1.

At user modeling step 10, the characteristics of a person (human) are modeled using artificial intelligence. Examples of modeled characteristics include, but are not limited to, the person's intentions, psychological state, and any changes to these intentions and state based on interactions with a virtual world. In other words, a model of a virtual user (which simulates the human user) may be created at step 10 based on a set of basic principles of a user including: (i) intentions of the user (e.g., whether the user is intending to just explore, learn more about a product, or buy a product); (ii) the time spent on the e-commerce system or platform (e.g., how long will the user dedicate to their e-commerce session or in-store shopping, and how will delays or psychological boosters impact it); (iii) any changes to their intentions or the time spent based on interactions within the e-commerce system or platform; (iv) any changes to their intentions or the time spent based on new information that they become aware (e.g., price changes, virtual testing, product reviews, availability, etc.); and (v) other data about the person that could be relevant within an e-commerce/shopping experience.

In some embodiments, the user's intent is modeled via a probabilistic network, which models the probability of specific actions at every point of the user journey through the e-commerce/shopping experience. For example, the user's intent may be modeled through one or more of the following statistical parameters: “P_find_i”, “P_intent_i”, and “P\hat{ }*_intent_i”.

The statistical parameter “P_find_i”, as used herein, corresponds to the visibility of option i within the e-commerce/shopping experience, expressed as a probability and conditioned on the current state of the e-commerce/shopping journey. This may comprise a probability tree providing the likelihood of finding a particular selection option at any point in the journey.

The statistical parameter “P_intent_i”, as used herein, corresponds to the level of match of option i to the user's intent, expressed as a probability and conditioned on the current intent of the user (which may or may not change at different points of the journey). At every step, there is usually a probability of the intent of the user to leave the shopping experience and abandon any further action. The exit intent may be referred to herein as “P_exit”, which is also conditioned on the current step of the user's journey. The “P_exit” for each step does not have an associated likelihood of being found since an exit is something the user can always do by simply moving away from the experience (i.e., there is no specific call to action to be found for an exit). In general, the sum of all “P_intents” for a specific step of the e-commerce/shopping experience will be 1.

The statistical parameter “P\hat{ }*_intent_i”, as used herein, corresponds to a modified intention probability adjusted for the experience's emotional impact on the user. “P\hat{ }*_intent_i” may be modeled as (1−|“m_i”|) (“P_intent_i”)+(“m_i”+|“m_i”|)/2 where “m_i” is an emotional boost factor parameter in the range −1 to 1 with −1 corresponding to a strong negative “dislike” emotion, 0 corresponding to no emotion, and 1 corresponding to a strong “like” emotion.

Illustratively, the emotional impact on a specific item would require all the “P_intent_i” parameters to be rebalanced such that the sum of all “P_intent_i” probabilities is 1. For example, if “P_intent_i” is initially 0.2 (i.e., 20% chance that the user selects option i given their current intent), and the user sees something (i.e., a sale, a visually pleasing image, etc.) that emotionally boosts their intent (e.g., with positive boost factor “m_i”=0.5), then the intention probability increases to 0.6. On the other hand, if there is a negative emotional experience (e.g., out of stock or delivery delay for desired item, price increase, etc., with negative boost factor “m_i”=−0.5), then the intention probability decreases from 0.6 back to 0.1.

In addition to the intention-based model outlined above, the impact of time of experience to eventual outcome of the e-commerce/shopping journey may also be modeled. In one embodiment, the impact of time may be modeled with the following parameters: “T_tot”, “T_wait”, “T_boost_i”.

The parameter “T_tot” corresponds to a total time that the user dedicates to the session. “T_tot” may be modeled as an exponential random variable with the following probability distribution:

$${f}_{T \_ Tot} ( t ) = \frac{{e}^{- t / {C}_{Tot}}}{{C}_{Tot}}$$

The parameter “T_wait” corresponds to a time that the user is willing to wait during any load/wait cycle. “T_wait” may be modeled as an exponential random variable with the following probability distribution:

$${f}_{T \_ Wait} ( t ) = \frac{{e}^{- t / {C}_{Wait}}}{{C}_{Wait}}$$

The parameter “T_boost_i” corresponds to an emotional boost impact on time (i.e., the user is willing to wait longer due to a positive emotional boost). “T_boost_i” may be modeled as a deterministic parameter (c_boost)*(m_i) where “m_i” is the emotional boost impact factor as described above. In general, the higher the emotional boost the longer a user is willing to wait, and vice versa.

Based on the above, if the current session time is greater than “T_tot”+sumᵢ (T_boost_i) (i.e., where the summation function here is over the set of emotionally impactful experiences that are actually experienced in the simulation), then the user ends their session without any further action and the simulation ends. Also, if the current wait time for the current specific section is greater than “T_wait”, then the user also ends their session without any further action and the simulation ends.

In one embodiment, the modeling of time in the simulation can be simplified with a page/step attrition parameter which accounts for the probability that a user leaves at any given user interaction step. For example, the number of steps a user takes (e.g., the number of buttons a user clicks) can be a simplified and representative measure of the amount of time they have spent, which can then be accounted for by means of a page/step attrition parameter instead of specifically modeling time.

In addition to intent and time, a variety of other parameters can be modeled regarding a user, including their emotional state, their schedule, as well as the time and date which would impact shopping intent. These parameters can be modeled to help estimate the likelihood of different options or results (e.g., including different shopping outcomes).

After completing user modeling step 10, method 100 proceeds to persona training 20. At step 20, the training can be done for a single group that is representative of the users (e.g., including the shopper's actual race, gender, age, and other demographics) or for multiple groups (i.e., one for each demographic group) with the multiple models then being combined based on the intended demographic distribution during the simulation. Also, pre-set model parameters can be used as an alternative to training.

Training step 20 comprises assigning values to the parameters initialized in modeling step 10. The values can quantify the expected behavior of users (e.g., intentions, time expectations, etc.) in the models of the virtual users created in step 10. For the example embodiment described above in relation to step 10, the parameters that will be quantified include “P_find_i”, “P_intent_i”, “m_i” for all i as well as “c_wait”, “c_boost”, and “c_tot” time constants.

This quantification can be done in a number of ways. One way is to have a representative group panel who can be polled or tested on regarding specific actions and wait times, with the polling/testing results being used to quantify the parameters. More specifically, and as one possible embodiment: “P_find_i” may be determined by the relative prominence (color, size, placement) of option i as well as the total number of options within the current state, “P_intent_i” may be approximated by asking a test panel to select their intended action in the current state and observe the percentage of people that choose option i, and “m_i” may be determined by polling the panel to observe their emotional reactions to a specific experience step. For the time related parameters “c_wait”, “c_boost”, and “c_tot”, these can either be determined by polling the panel or estimated based on actual recordings of shopping sessions of the panel members.

Once these parameters (and any other relevant parameters) are estimated upon completing step 20, method 100 proceeds to simulation step 30. As described above, the trained model or virtual human can be singular in that it represents all demographic groups, or it can be group-specific or multiversal to reflect different model parameters for each specific demographic group (e.g., white-men-65+, black-women-18-29, hispanic-women-45-64, etc.).

At simulation step 30, a large number of virtual users are simulated by executing a series of input actions (e.g., keyboard entries, mouse clicks, etc.) on a model of the e-commerce website, application, or platform. The simulation may be conducted by classifying all of the users as a single group (e.g., with identical model parameters), or by randomly selecting the users from a pre-determined set of demographic groups (e.g., race, gender, age, etc.) and using the group-specific model parameters.

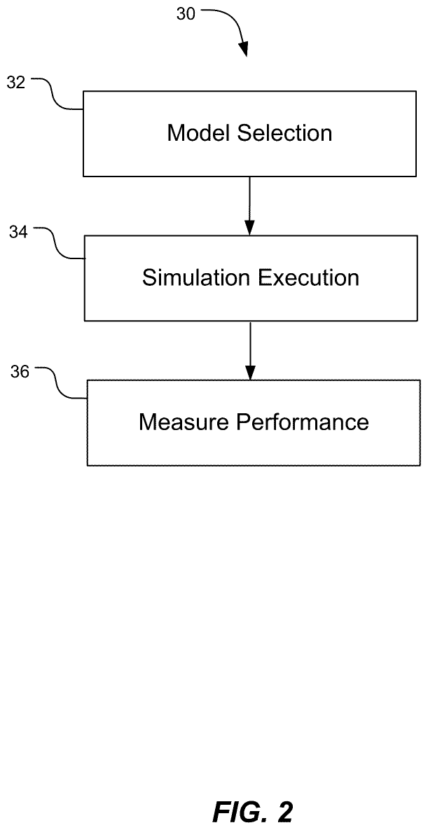

FIG. 2 illustrates an exemplary sequence of steps that may be performed as part of the simulation step 30. In the illustrated embodiment, the simulation begins at virtual user selection step 32. Step 32 comprises selecting a virtual user model (e.g., based on a single overall group, or selection from a specific demographic groups) to obtain a specific set of model parameters. After selecting the virtual user model, the simulation proceeds to execution step 34.

At execution step 34, the simulation is run step by step through an example of the user's shopping process. Stated more specifically, step 34 comprises modeling both the progression in time of the user as they navigate at different shopping steps, as well as the likelihood of them choosing different options or executing different input options (e.g., such as clicking buttons on an e-commerce website) based on the model parameters of the model selected in step 32. For example, on a typical e-commerce platform or website, the parameters “P_find_i” and “P\hat{ }*_intent_i” may be used to determine the probability of selection for every option i on the page, and these options may be randomly selected while accounting for the respective probabilities. Once an option is randomly (but with correct accounting of probabilities) selected for a certain section of the website, the process may be repeated for the next sections of the website.

In some embodiments, the “T_tot” and “T_wait” parameters are randomly sampled based on the probability distribution obtained from the model parameters. In such embodiments, specific load times (which need to be accounted for in the simulation) as well as the overall user session time (which also needs to be accounted for) may also be tracked. If at any point a load cycle exceeds “T_wait”, then the user's session ends and the simulation stops. Further, if the total session time exceeds “T_tot”+sumᵢ(T_boost_i), then the user's session also ends along with the simulation. In the termination of the total session expiry time, emotionally impacting experiences that are experienced along the way may be accounted for in determining the “T_boost_i” time adjustments.

In the process of completing execution step 34 for a shopping simulation, the user may select options which add items to cart. Just as the other options, every cart-impacting option has a probability model and the likelihood of the user selecting them may be accounted for.

After completing execution step 34, the simulation proceeds to measure the performance of the user's session at step 36. The performance measurement in step 36 may be modeled as outlined above. However, in the event of a successful payment and checkout, the simulation ends and the amount of purchase is noted in step 36. As a final parameter, the likelihood of the user returning back to the simulated experiences may be modeled to determine the likelihood of repeat customers.

Referring back to FIG. 1, method 100 may comprise repeating simulation step 30 a large number of times. After repeating simulation 30, the percentage of successful shopping outcomes along with the specific items purchased and the total basket size may be recorded and analyzed. Based on this, a detailed report may, optionally, be generated at step 40 to provide insights on the drop-off points in the experience, the reasons for users leaving, the most popular items purchased, the conversion rates and basket sizes, etc.

The final report generated in step 40 can be used by designers/builders of actual shopping experiences (whether e-commerce or in an actual store). By performing method 100 across several possible options and configurations (as well as experiences), the designer/builder can select the specific configuration that resulted in the highest conversion rates, the largest basket sizes, and/or any other desired result that is observed during the simulations. Furthermore, since method 100 can be performed on any shopping experience that is public, it can be used for competitive evaluation of different shopping experiences, or for an internal audit of shopping experiences across different divisions.

Other aspects of the invention are described in more detail below with reference to a simplified demonstration of an e-commerce prediction system implementing method 100 described above. In the simplified demonstration, the experience of a shopper looking for an action toy on an e-commerce website like Amazon™ is modeled based on the more common elements of the experience (i.e., rather than every minute detail of the Amazon web experience). In the demonstration, the simulation was conducted based on the following parameters: a highspeed internet connection with a typical web response time of about 0.1 seconds, a user who is committed to making a purchase with “c_tot”=600 seconds, “c_wait”=20 seconds, and “c_boost”=60 seconds, and the user spending about 30 seconds on the product gallery step, and about 30 seconds on the product detail page step, and about 5 seconds on each other step.

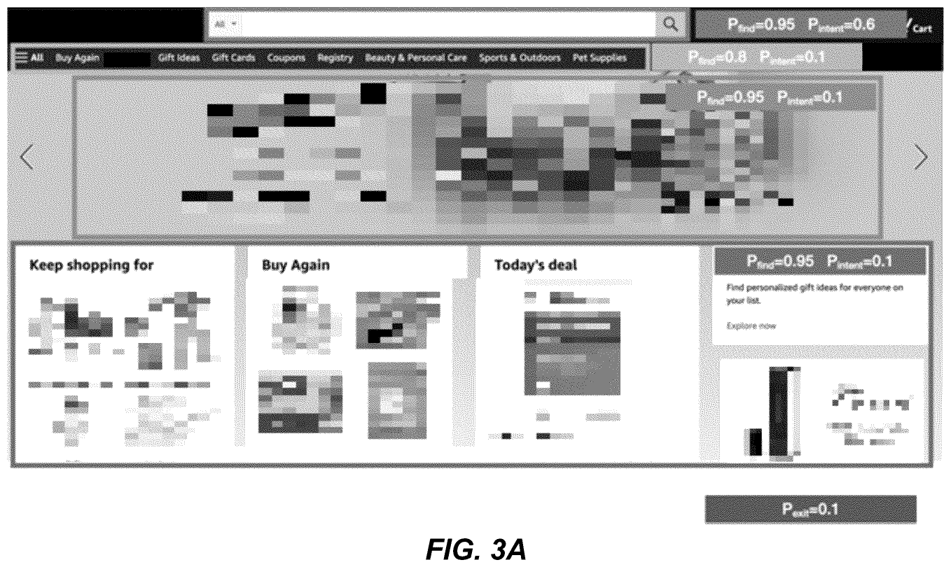

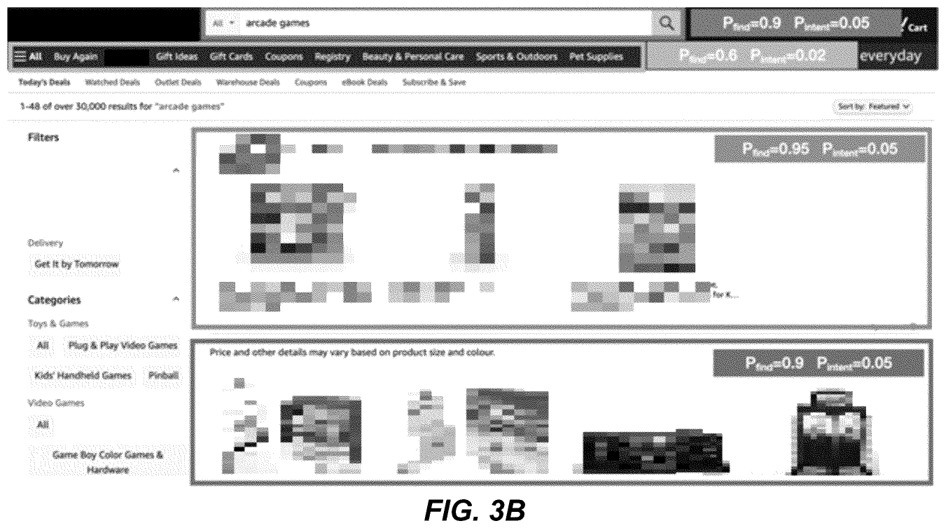

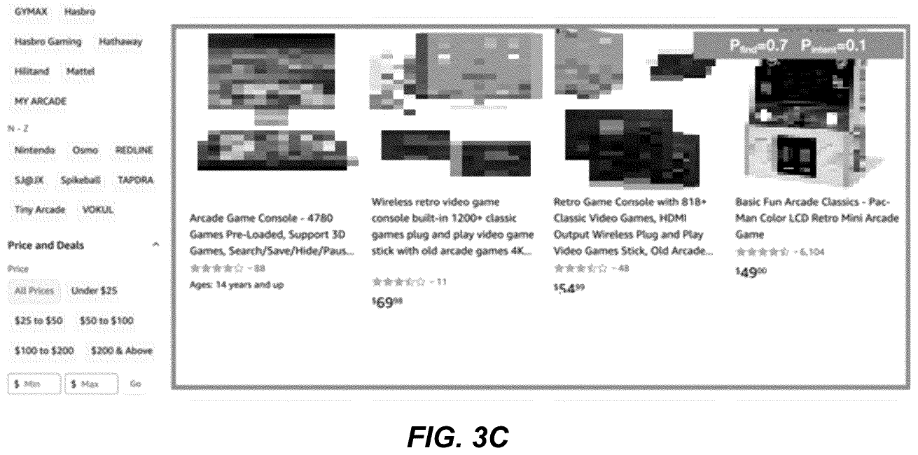

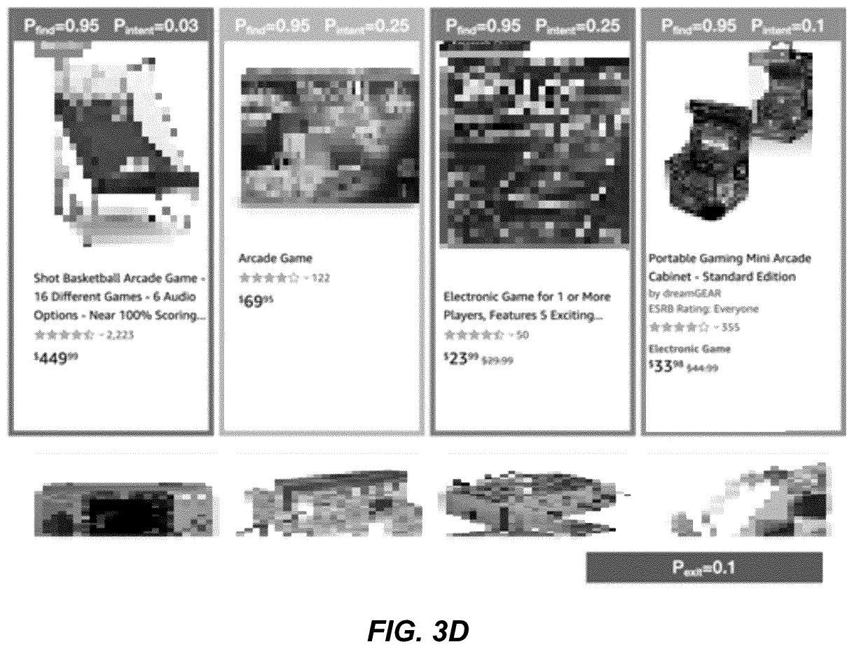

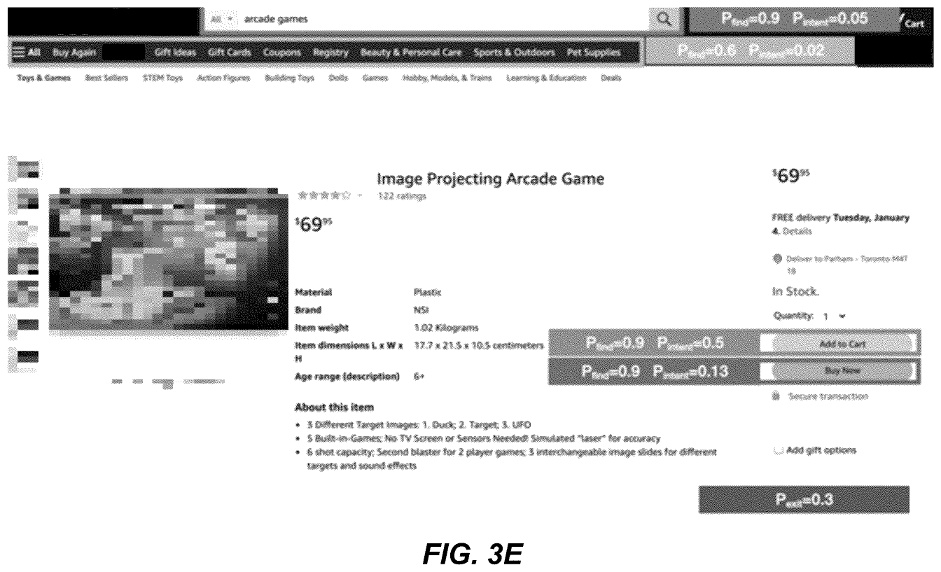

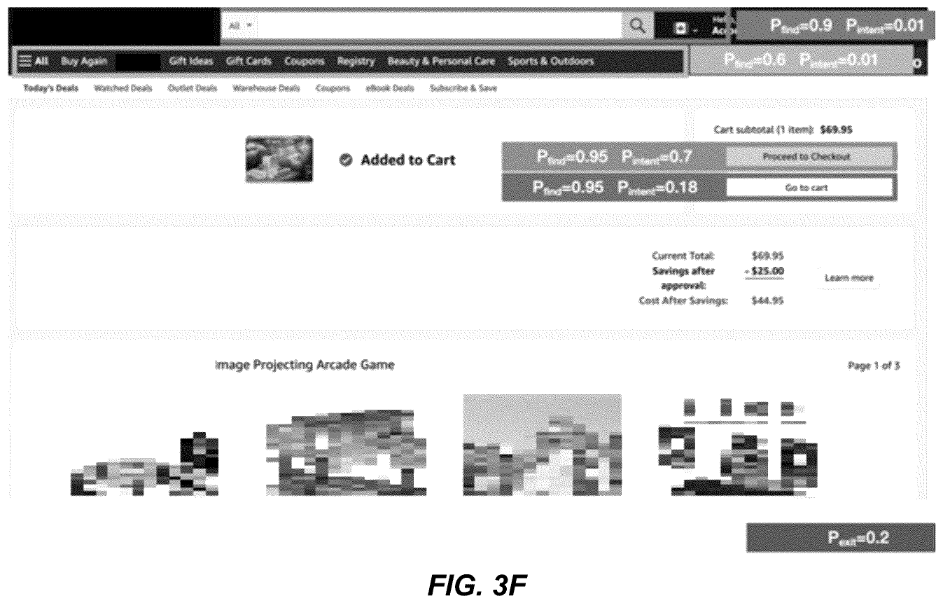

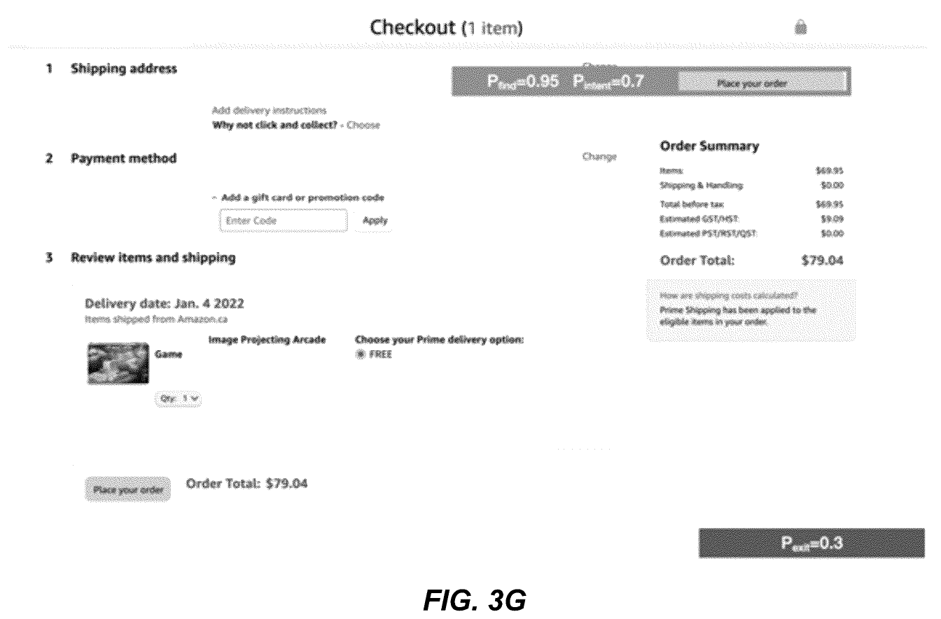

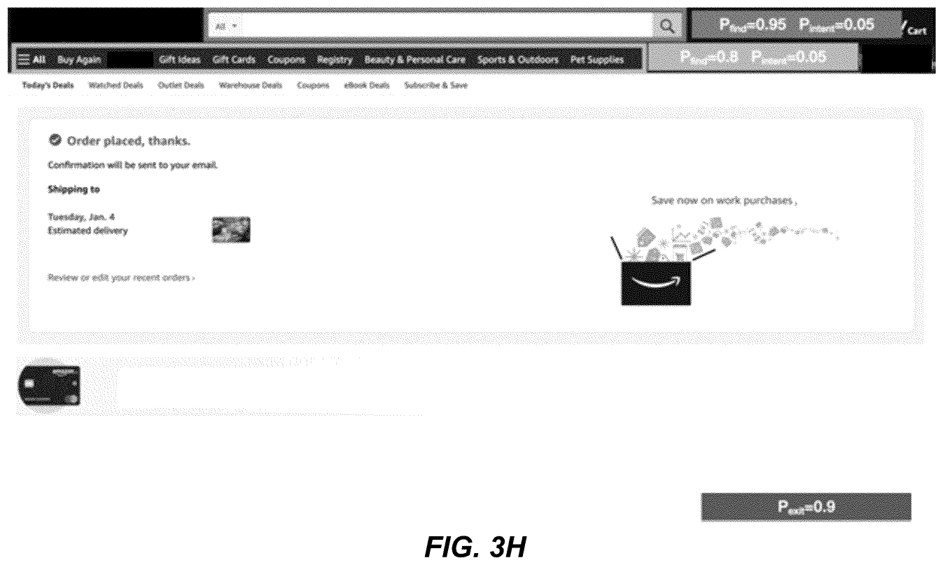

FIGS. 3A to 3H illustrate various parameters used in a simplified demonstration of conducting method 100 on an exemplary e-commerce website. This includes the identification of clickable options within pages of the e-commerce website, along with the associated probabilities of the user finding or noticing a feature and their intent to select the feature as shown in FIGS. 3A to 3H.

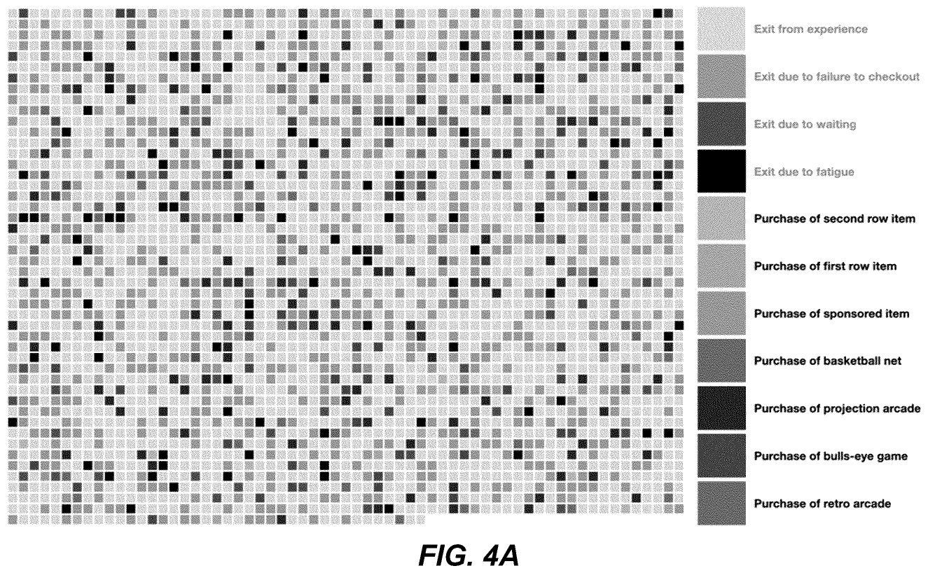

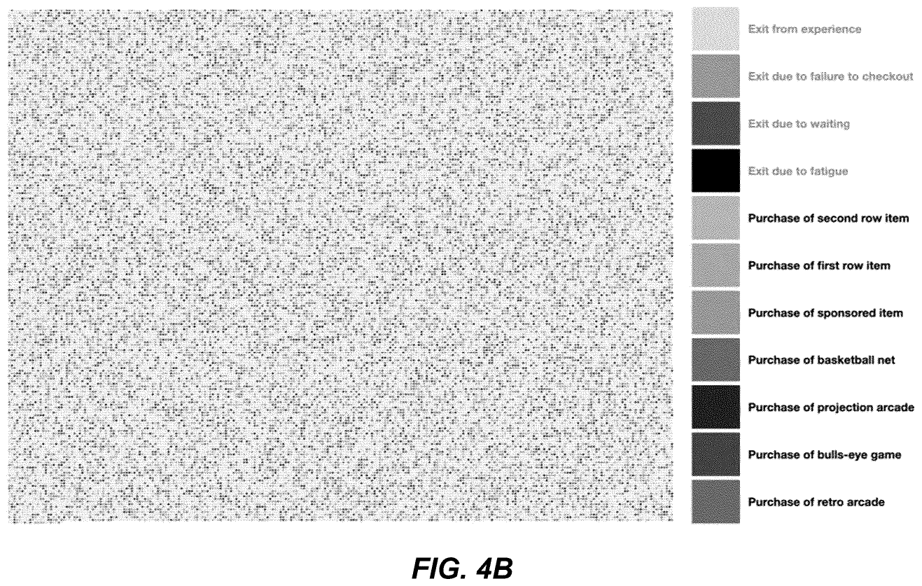

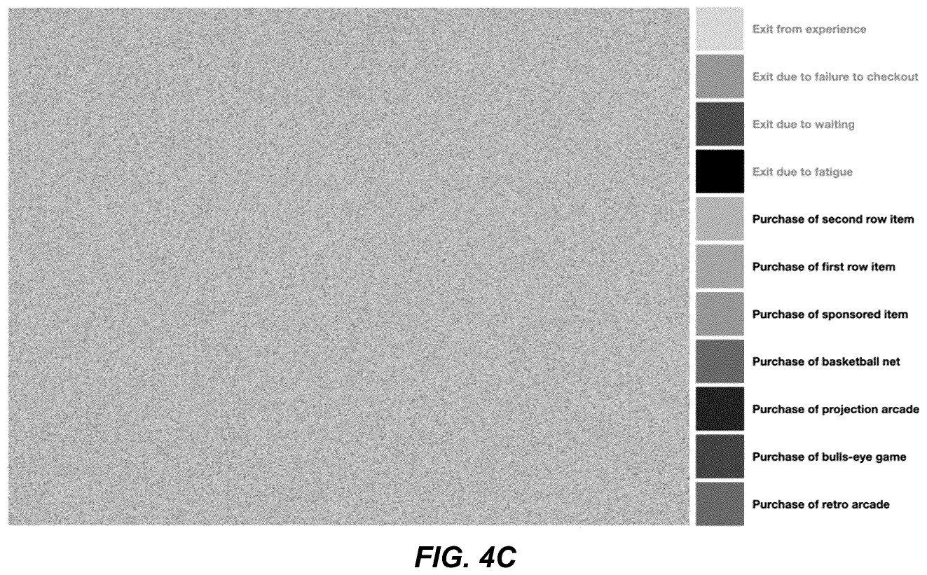

The inventor conducted simulations involving three thousand (3,000) virtual shoppers based on the above model, obtaining the results shown in FIG. 4A. However, even with 3,000 shoppers, there may be variability in the conversion rate and average purchase statistics (i.e., repeating the simulation sequentially results in wide-ranging statistics). To get a more stable number, the inventor also conducted simulations involving fifty thousand (50,000) virtual shoppers, obtaining the result shown in FIG. 4B. The inventor next conducted simulations involving over 1.5 million (i.e., 1,551,550) virtual shoppers, obtaining the result shown in FIG. 4C along with a conversion rate of 10.9% and an average purchase price of $70.09. In FIGS. 4A to 4C, each colored box or pixel is indicative of the outcome of a virtual-shopper simulation result (e.g., an exit outcome, an outcome of purchasing a specific item, an outcome of purchasing an item on a particular row of a webpage, etc.) wherein the colors are indexed as per the legend on the right hand side of each figure.

Further aspects of the invention relate to methods of modeling interactions between user systems and online websites, applications, or platforms (e.g., e-commerce websites, applications, or platforms) based on incremental changes in user experience. While the method 100 described above can be effective at understanding the entire shopper behavior of an e-commerce or in-person shopping experience, it requires detailed user behavior and user demographic modeling which might be difficult to obtain in some cases. In an alternative embodiment of method 100 only small changes are contemplated. In such embodiments, the behavior modeling in step 10 is limited to small “delta” changes to the experience, which can be easier to obtain and/or estimate compared to the entirety of parameters for the entire website or application experience.

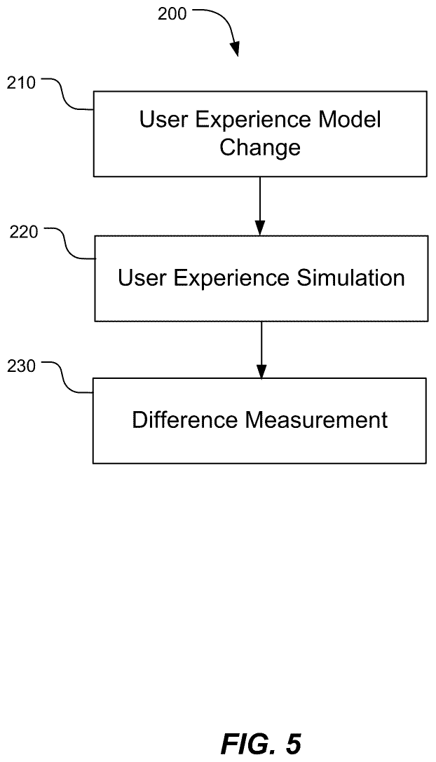

In such embodiments, the delta modeling method 200 can be accomplished in a sequence of steps shown in FIG. 5. First at step 210, the following parameters are defined: “i” is defined as a unique index to all actionable items in every page of the experience, “sᵢ=k” is defined as the mapping between every actionable item “i” clicks to another item/step in the experience (i.e., from item i to item k), and pᵢ is defined as the probability of the user selecting item i within the page where item i appears in. Every step of the experience also has an exit item involving the user leaving the page. The sum of the probabilities pᵢ for a specific step add up to 1. pᵢ can be estimated by observing the traffic behaviour of users on the web experience. If nᵢ people select item i, and a total of N people arrive at the step in which i appears in, then pᵢ can be estimated as nᵢ/N. Alternatively, pᵢ can be estimated based on the size and visibility of item i, or based on input from a user focus group about the likelihood of selecting item i.

With delta modeling method 200, the performance of a slightly modified e-commerce experience (i.e., an experience involving subtle changes to a few items) can be measured. For example, in the case where only one item j is adjusted such that the new “p_(j\hat{ }*)” changes to “(p_j+Δ)”/(1+Δ) (i.e., where Δ can be positive or negative), an increase in the likelihood of selection of an item on a step in the page would require a corresponding decrease in the likelihood of selection of other items in the page. So, for all items i on the same page as j, their new probabilities “p_(i\hat{ })” become pᵢ/(1+Δ).

After modeling the user experience change in step 210, method 200 proceeds to conducting the user experience simulation in step 220. If step 220 is conducted in accordance with method 100, but instead with an added emotionally impacting visual just for the “projecting arcade game” which would increase the “p_intent” of selecting that item in the search results from 0.25 to (0.25+0.2)/(1+0.2)=0.375 (i.e., with a Δ of 0.2 with proportionate decreases in the pᵢ values of the other items in the same page), then the conversion rate increases from 10.9% to 11.2%, with a similar average purchase price of $70.22 (as compared to $70.09 from before). Conversely, if step 220 is conducted in accordance with method 100 but now with a Δ of −0.2, then the conversion rate decreases to 10.3%, and the average purchase price decreases to $61.84. The differences in conversion rate and purchase price (or other differences) can be measured in step 230.

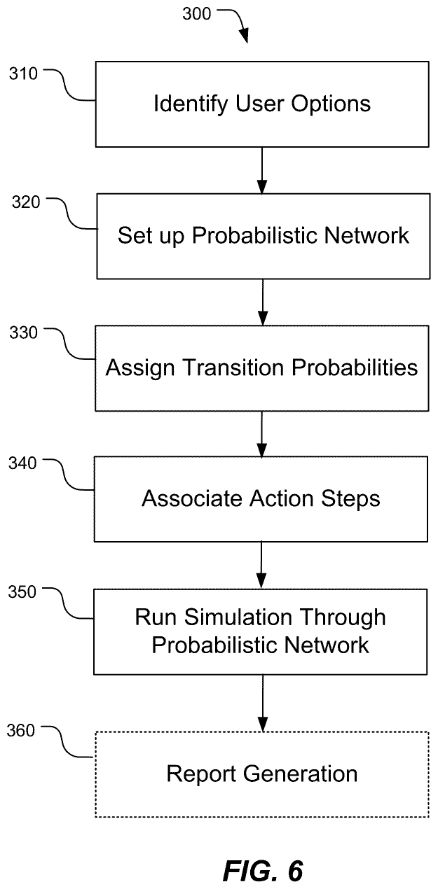

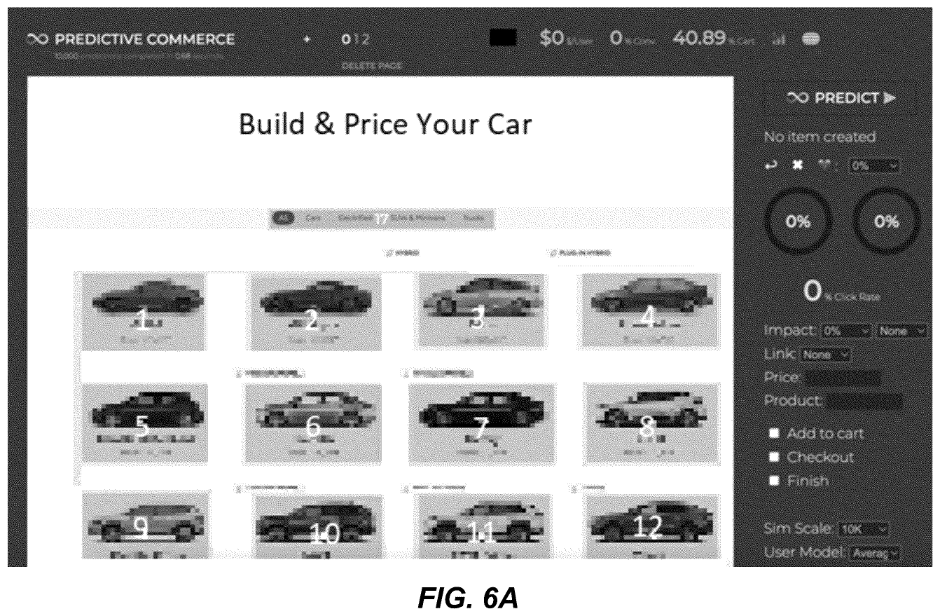

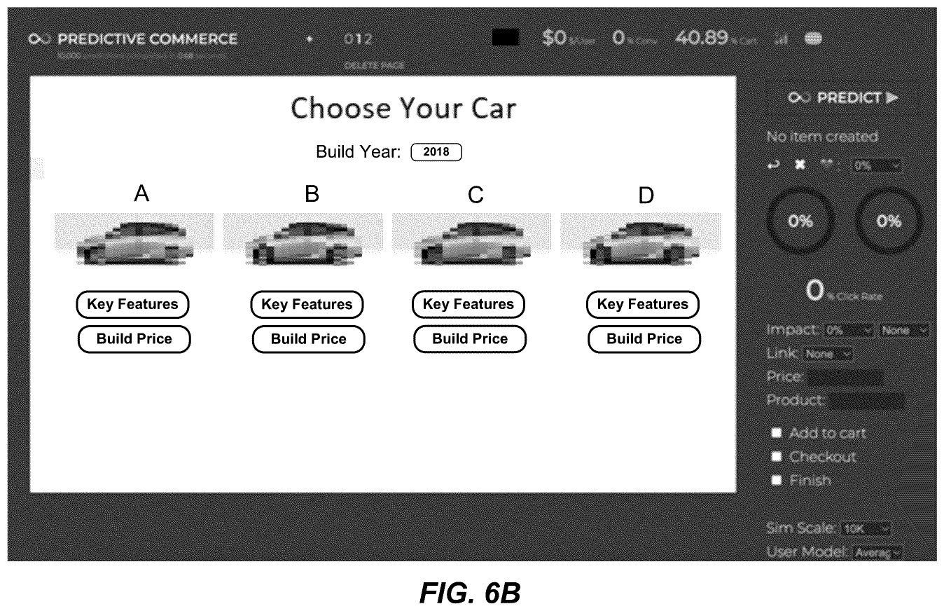

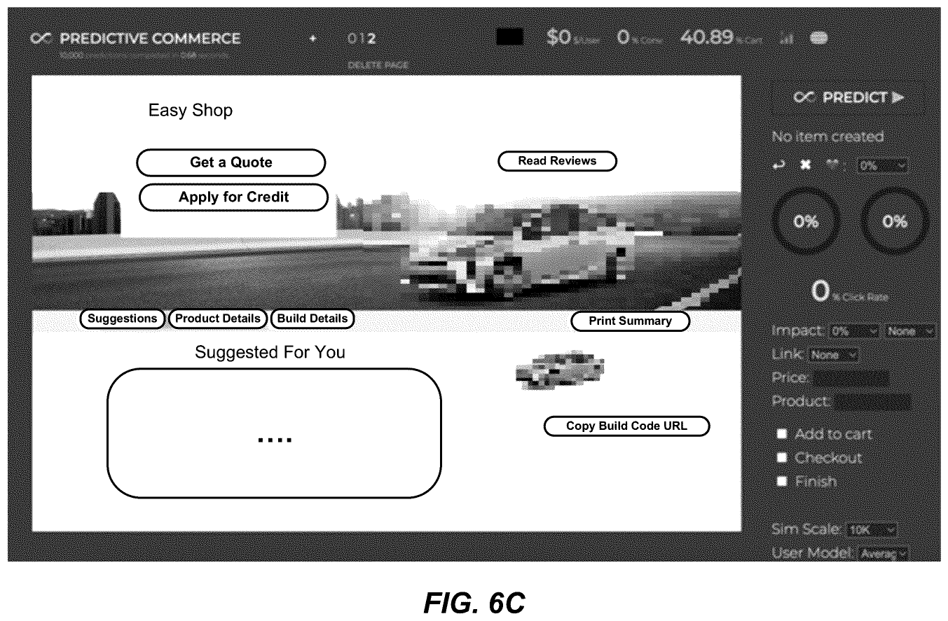

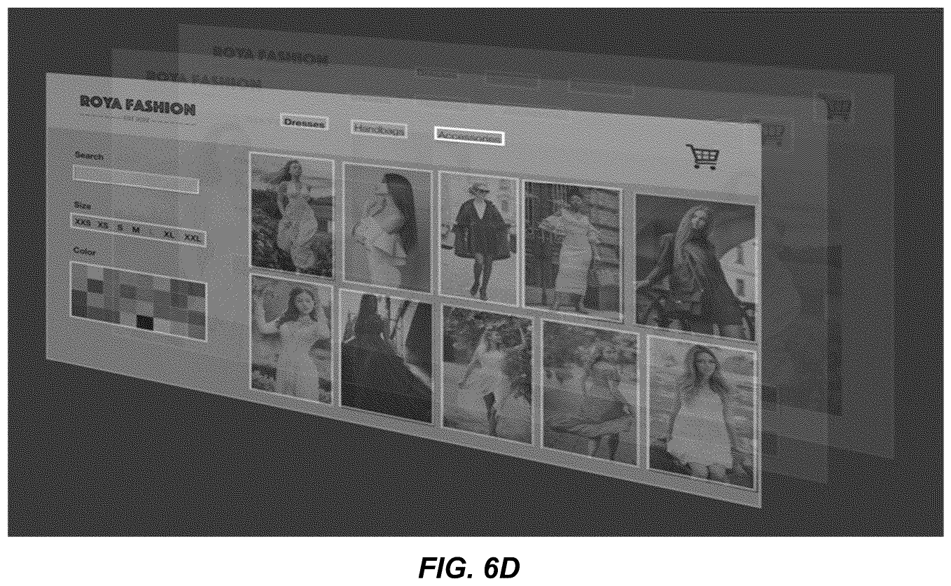

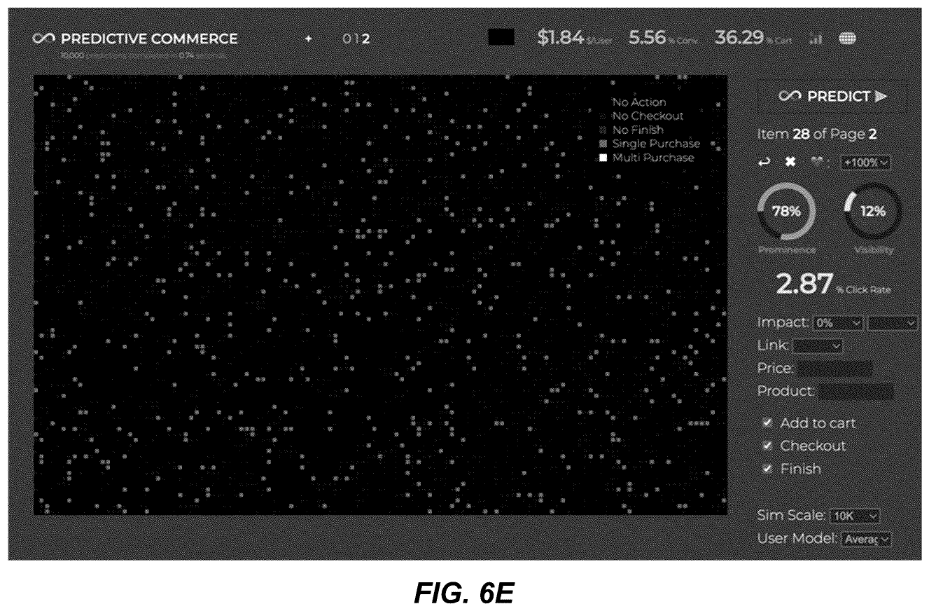

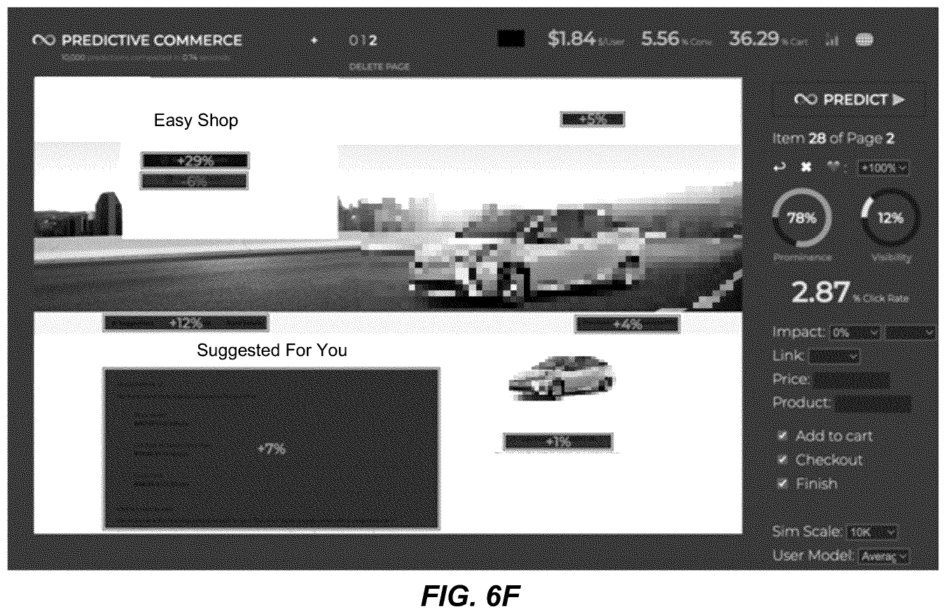

Referring now to FIG. 6, an alternative method 300 of simulating the interactions between a user system and a user experience platform (e.g., an e-commerce platform) is described in more detail below. By modeling the options on one or more pages of an e-commerce experience as a probabilistic network (e.g., a Markov chain, a Markov network, a Markov Random Field with global parameters, or the like), with each having their own probabilities of transition, the simulation can be conducted as a numerical progression through a probabilistic field. For example, method 300 may be performed to simulate a user transitioning from the product option, where a particular product with a price is selected, to another option where the product is added to cart, to another option where the user checkout takes places, and then to a final option where the purchase is finalized. In another example, method 300 may be performed to simulate a user transitioning from adding the product to cart to dropping it out prior to checkout being completed.

In the example embodiment illustrated in FIG. 6, method 300 begins at the initial step 310 of identifying all user options of the e-commerce experience, followed by the step 320 of generating or setting up a probabilistic network that defines the likelihood of transition between the identified options, followed by the step 330 of assigning transition probabilities based on the option details (e.g., including but not limited to option visibility, prominence, and emotional context), followed by the step 340 of associating some of the nodes of the probabilistic network with action steps in the e-commerce experience (e.g., including but not limited to adding a product to cart and completing a checkout), followed by the step 350 of traversing through the probabilistic network to predict virtual e-commerce user behaviour (e.g., through the e-commerce experience based on the transition probabilities and action steps obtained in the previous two steps), and optionally followed by the step 360 of measuring aggregate simulation performance results and using it as an indication of the efficacy of the overall e-commerce experience. Details of each step in method 300 are described in further detail below with reference to FIGS. 6A to 6F.

At step 310, the user options of the e-commerce experience are identified. The identification of user options (i.e., elements of the e-commerce experience that the user can select) can be done by means of an identification application. In the identification application, each e-commerce web/app option is either manually or automatically identified. FIGS. 6A to 6C illustrate this example on a car buying website. FIG. 6A illustrates the identification of e-commerce options that a user can select. The identification of different options can be done across a number of different app/web pages, as shown in FIG. 6B (i.e., second page of a car purchasing web experience) and FIG. 6C (i.e., third page of car purchasing experience).

Step 320 comprises generating a probabilistic network that relates each option to subsequent options on the e-commerce web/app page. This could, for example consist of probabilities that a user would select subsequent options based on the current option that has been selected, in which case the probabilistic network would resemble a Markov network, a Markov Random Field, or the like. In the probabilistic network, the nodes may correspond to the identified options and the edges may correspond to the transition dependencies between the identified options.

In one embodiment, the probabilistic network is a three-dimensional probabilistic network, or alternatively, a three-dimensional Markov Random Field or Markov Network. In such embodiments, each two-dimensional plane may correspond to a probabilistic network for one section or page of the e-commerce experience, and the third dimension may correspond to the interconnection of these 2D networks across multiple sections or pages. An example depiction of the three-dimensional probabilistic network is shown in FIG. 6D.

At step 330, the transition probabilities from one option to another is assigned to the probabilistic network. The transition probabilities may be obtained from one or more of: prior knowledge about the web/app experience, the size or prominence of the option, the emotional affinity or emotional context of the option with users (e.g., a SALE sign, a specific feature or service, or a unique color), the visibility of the option (e.g., is it above or below the fold), human identified behaviour input or data from human interactions with the site, and any other characteristic of the e-commerce experience.

Step 340 comprises obtaining the action steps in each step of the e-commerce experience. Every option selected may have specific action items associated with it. For example, one association may be the name and price of a product. Other associations may include, but are not limited to: links to subsequent pages of the experience, the addition of a product to cart, checking out, or finishing with the entire experience. The options can be selected by the person entering the e-commerce specifications. Exemplary options include, but are not limited, to: custom tags or elements as reaching out to the company, booking an appointment, etc.

In many cases, certain actions may impact the transition/selection probabilities. For example, if an option has a checking out feature, then the checking out feature will likely result in a reduction of selection for that option since users are likely more careful about checking out. Hence, either the user profile or the person entering in information for the experience should specify any changes to the transition/selection probability.

Once the probabilistic network and the associated transition probabilities and actions are defined in steps 330 and 340, the user experience for one or more virtual users is simulated in step 350. This simulation comprises starting at the beginning of the e-commerce experience (likely the first page), and then traversing through or otherwise selecting each option in the experience based on the transition probabilities. For example, if in the first page there are 2 options, one with a click rate or transition probability of 65% and another with a probability of 35%, then there is a 65% chance that our virtual user would select the first option, and 35% chance of choosing the second option. However, to make the simulation more realistic, a dropout factor (i.e., corresponding to page/step attrition) accounting for users who get tired of the experience may be incorporated. For example, if the dropout is 10% (i.e., 10% chance user does not select any initial option), then the selection probability would be reduced to 58.5% for the first option and 31.5% for the second option.

At step 350, the above process for the virtual user may be repeated until either the user drops out of the experience based on the probabilistic dropout factor, or the user gets to an option that finishes the experience. To overcome practical computational issues, the total number of steps may be limited to reduce or otherwise avoid the possibility of encountering a very unlikely infinite loop (e.g., at 1000 steps). Once the virtual user simulation is complete, one or more of the following may be analyzed and accounted for: the products added to cart (if any), the products checked out (if any), the results of the checkout completion (if complete), and any other relevant actions, steps, or results from the experience.

Step 350 may be repeated for a large number of users (e.g. 1 million users, 100,000 users, etc.), and the overall statistics about the web/app performance in conversions, sales, or any other metric of relevance may be generated in step 360. FIG. 6E illustrates the result of an example car buying experience, with the aggregate statistics shown at the top right hand corner, and the results of each of 10,000 simulations being shown as a dot with the associated color indicating whether each virtual user added a product to cart, checked out, or finalized purchasing a product.

Method 300 enables or otherwise provides an automated method of optimizing the user experience of e-commerce websites and applications. Here, the system implementing method 300 can systematically (or randomly, or by any other method) perform alterations to the identified user options (e.g., increasing the transition probability of one or more options) and compare the resulting metrics with those of a baseline (e.g., original) with the initial transition probabilities. By performing this process multiple times, the system is able to find out which changes result in a successful outcome or optimal results (e.g. optimized for performance metrics such as sales/revenue), and which changes result in the worst outcome. FIG. 6F illustrates this analysis performed on a specific page of a car selling application. As shown in FIG. 6F, increasing the transition probability of one option can lead to a 29% increase in sales/revenue as compared to the current (baseline) metrics.

### Analysis of Website

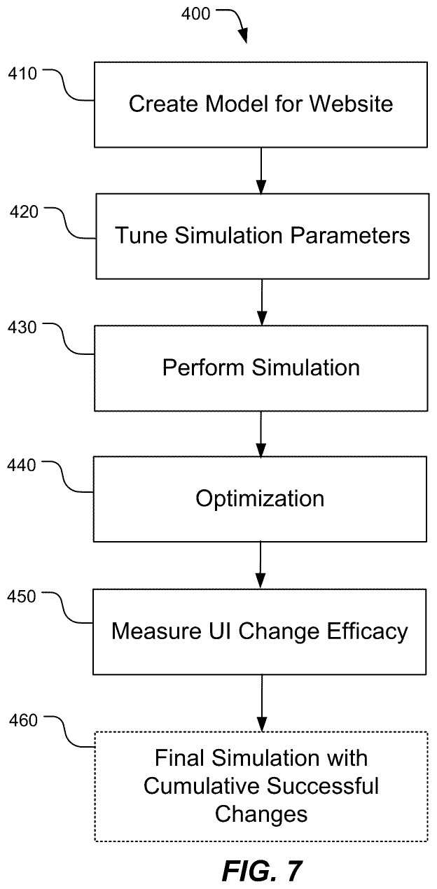

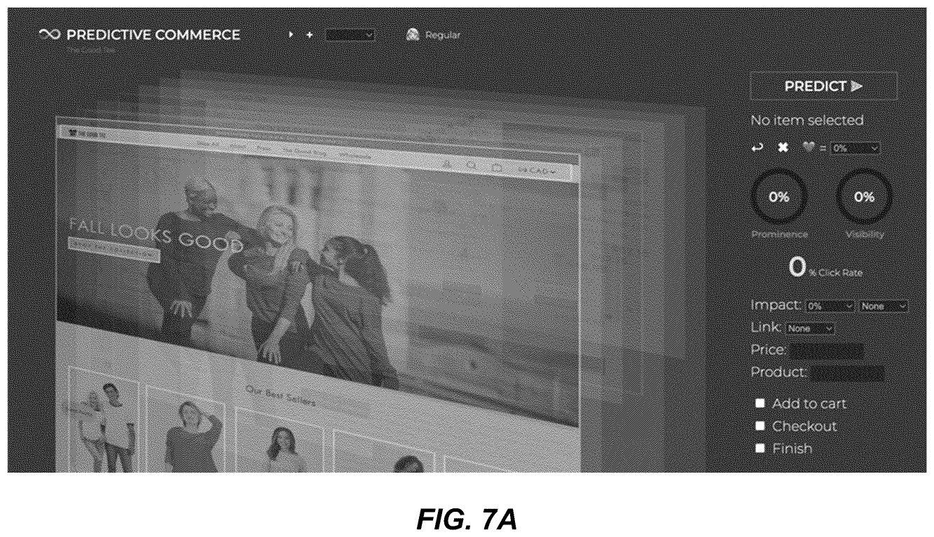

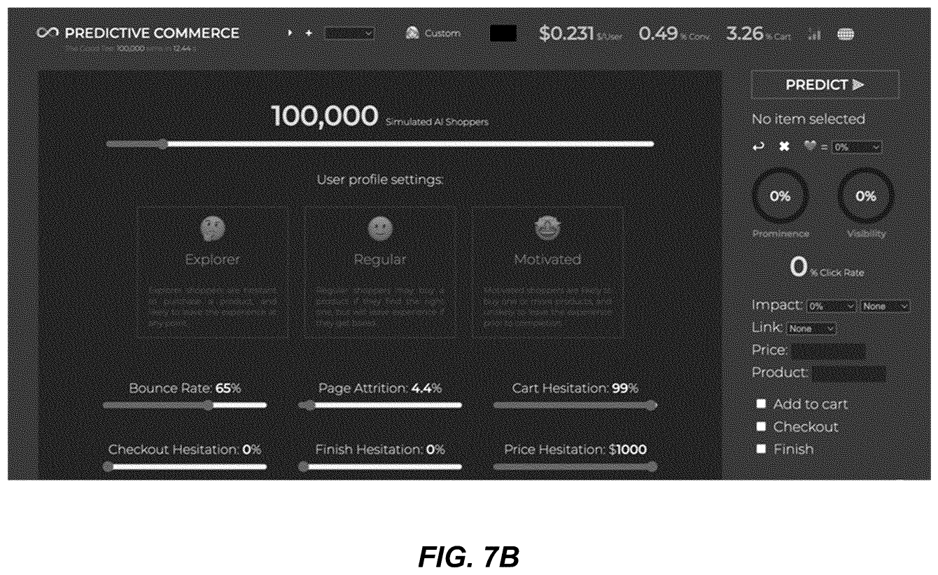

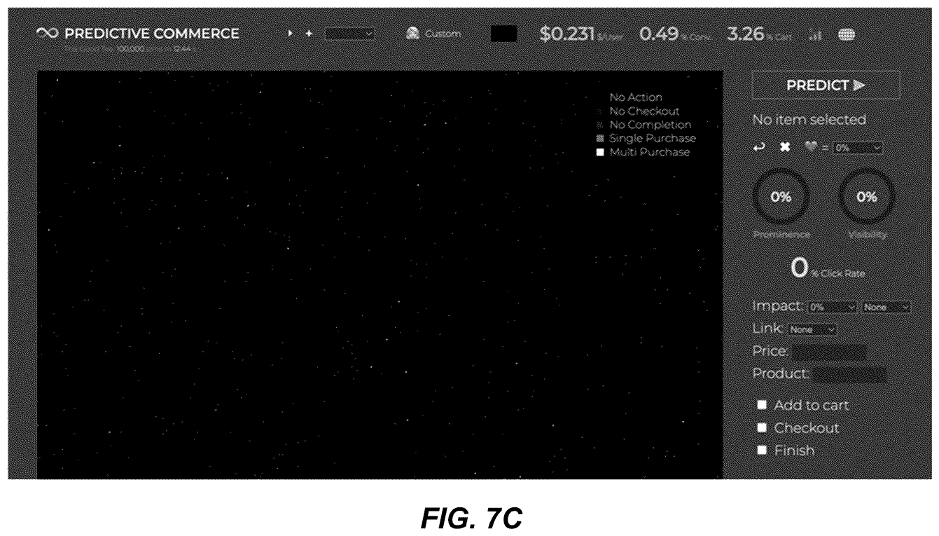

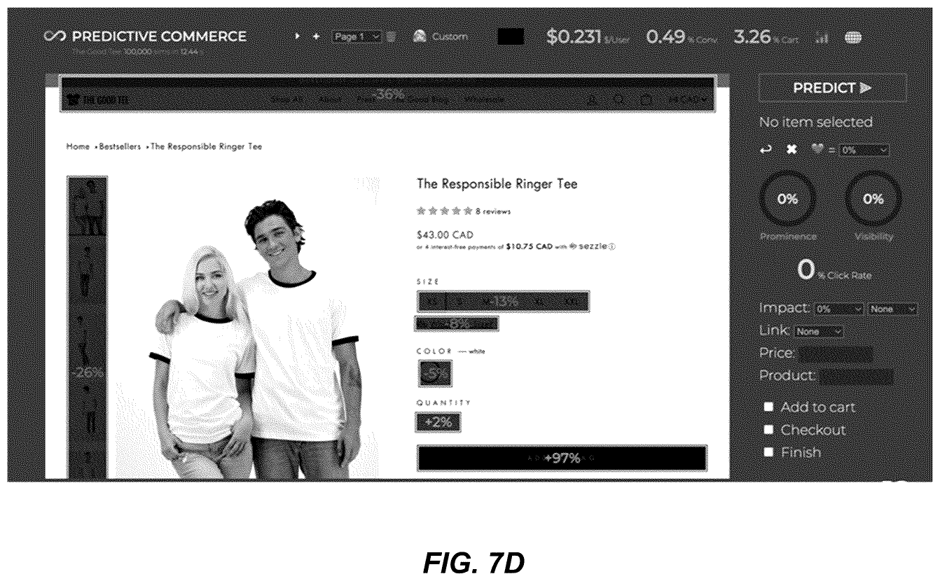

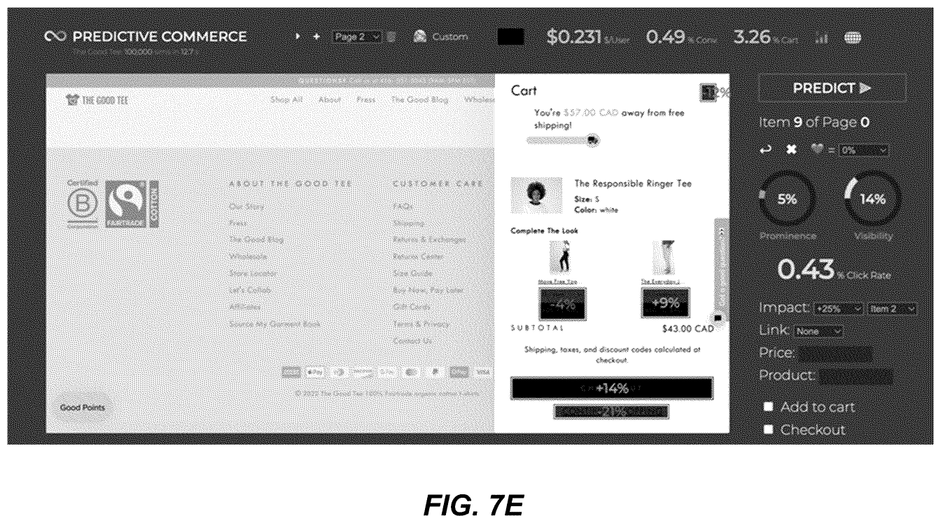

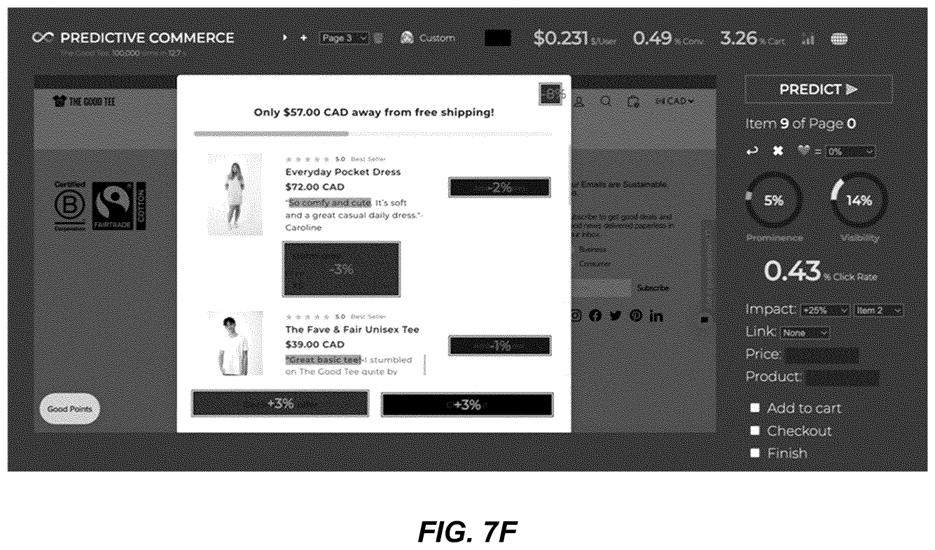

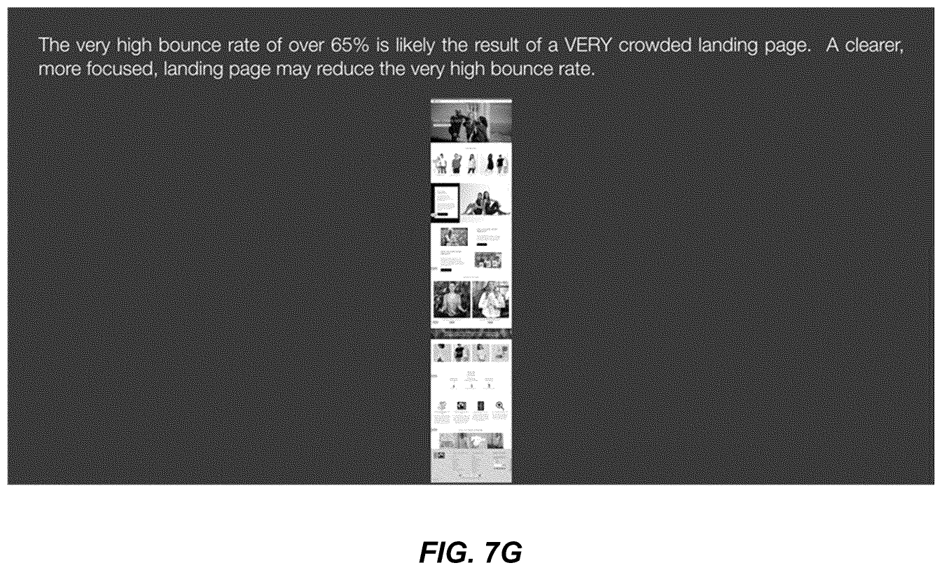

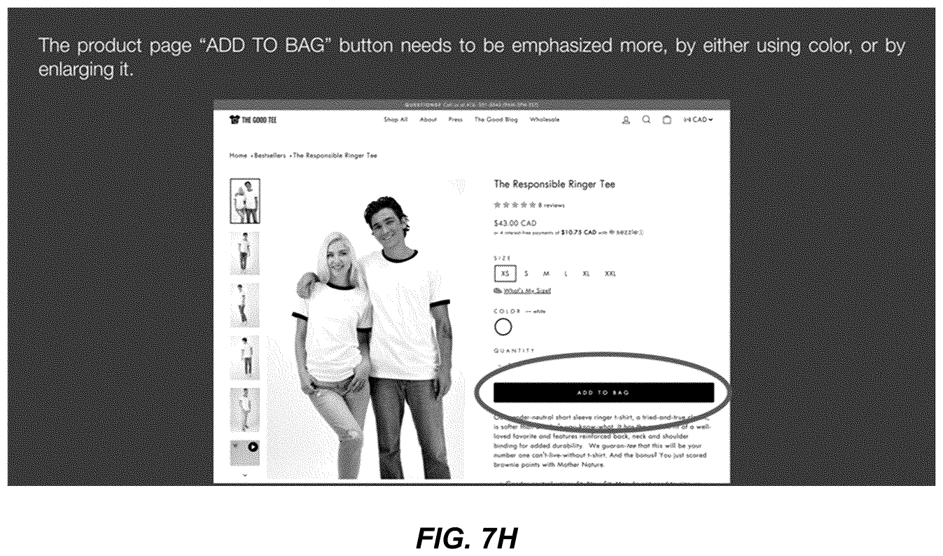

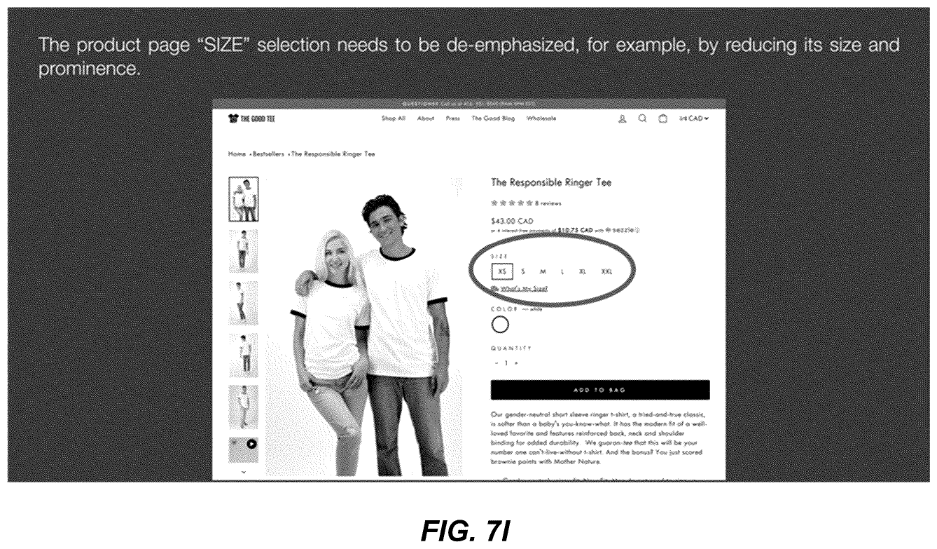

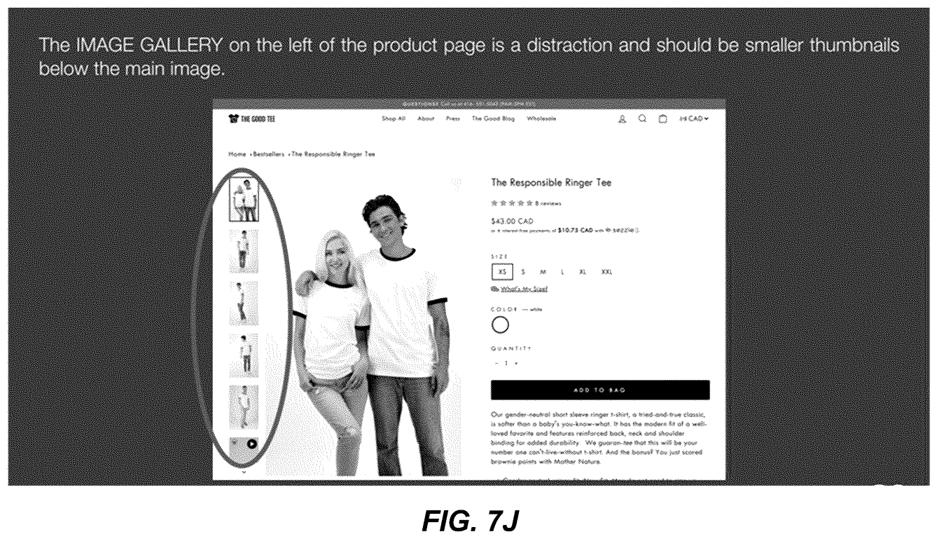

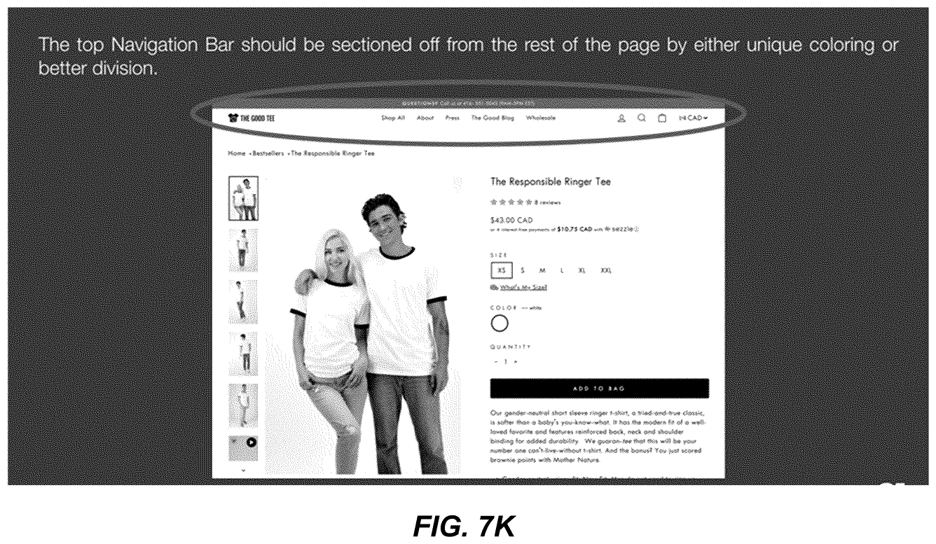

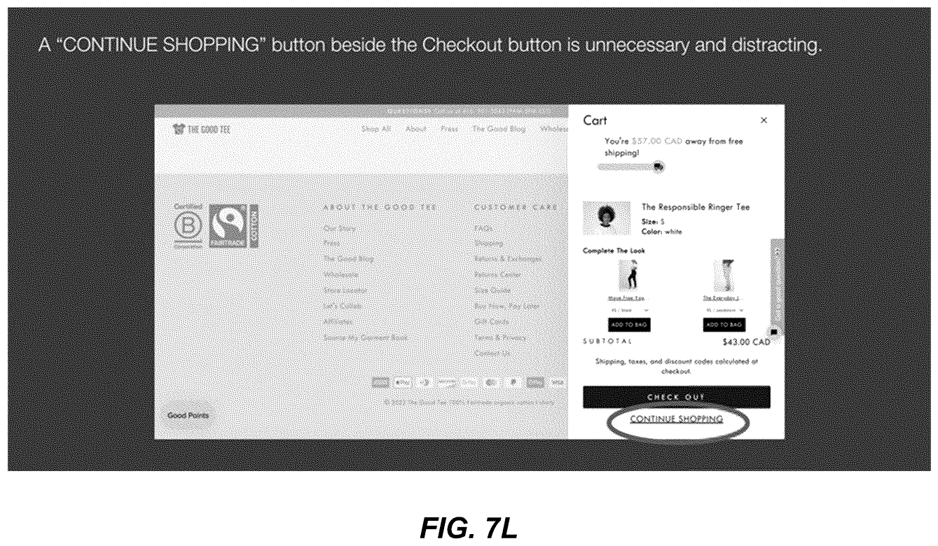

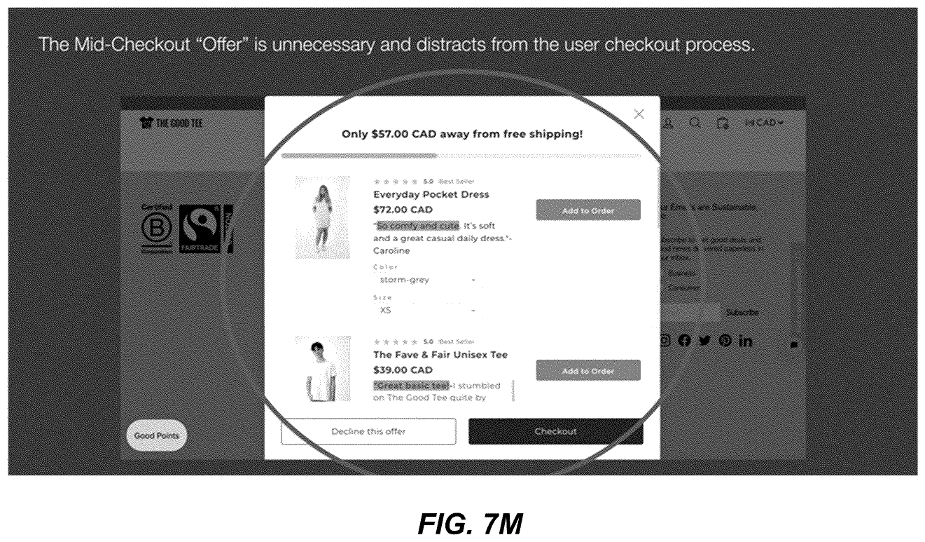

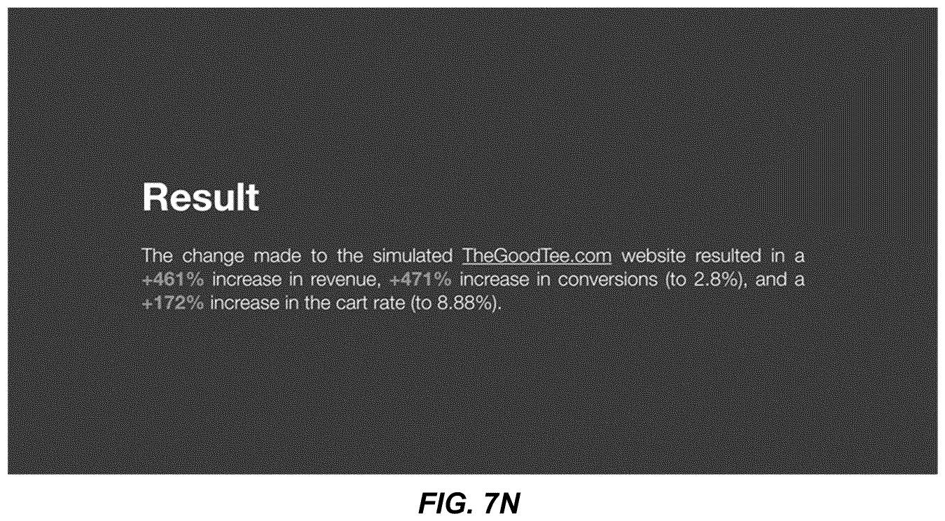

Referring now to FIG. 7, an example that illustrates the steps in a method 400 of analyzing a website is described in more detail below. As part of method 400, the parameters of the simulation may be tuned to match the behaviour of actual users of the target website.

Method 400 begins at step 410. At step 410, a model of the target website is created. This model is comprised of associated bounding regions for the most important elements (or alternatively, all elements) of the target website, including buttons, labels, entry forms, images, etc. FIG. 7A illustrates an example model of a website.

Next, the simulation parameters (including but not limited to bounce rate, page/step attrition, cart hesitation, checkout hesitation, etc.) are tuned at step 420. The simulation parameters may be tuned so that, when simulated on a large number of AI-generated shoppers, the resulting performance metrics are close to the actual metrics of the site, including conversions, cart-rate, bounce-rate, etc. If data for the actual website is not available, a generic user model can be used for general e-commerce sites. FIG. 7B illustrates the GUI of an application performing step 420 according to an example embodiment.

After tuning step 420, method 400 proceeds to step 430. At step 430, an initial simulation is performed with the simulation parameters of step 420 to find out the initial baseline performance of the site, with performance measured based on any combination of revenue, conversions, and cart-rate (see FIG. 7C).

After simulation step 430, method 400 proceeds to optimization step 440. At step 440, an automated optimization analysis of the most critical (or alternatively, all) pages of the e-commerce website is performed. This analysis would sequentially increase the affinity, size, or visibility of a specific element, and compare the performance metric for the modified website with the baseline. If the result indicates a positive change in a performance metric (e.g. more revenue, or a higher conversion), then the modification was successful. If the result indicates a negative change in a performance metric, then the modification was unsuccessful and the modified element should ideally be reduced in visibility/affinity/size. This can be evaluated on a per-item basis, as shown in FIGS. 7D to 7F, or on any subgroup of items. In FIGS. 7D to 7F, a negative percentage (shown in red) indicates that a reduction in visibility, affinity or size should be made, whereas a positive percentage (shown in green) indicates that an increase in visibility, affinity, or size should be made.

After completing optimization step 440, method 400 proceeds to step 450. Step 450 may comprise measuring the efficacy of the user experience change. Based on the measurements and the results of the above analysis, a series of recommendations can be made in step 450. The recommendations may outline which items should be emphasized and which items should be deemphasized. An example set of recommendations for a specific target website is shown in FIGS. 7G to 7M.

Optionally, a final simulation with all cumulative recommended changes may be performed at step 460. The “overall” performance results of the final simulation can be shared with the website manager to demonstrate the potential of their e-commerce website should all recommendations be made (see FIGS. 7N and 70).

### Comparative Analysis

With the proposed methodology of using AI-generated virtual shoppers to measure performance metrics on any e-commerce website (or app, or experience), as described above, it is also possible to compare multiple different designs or implementations of a website/app (or, alternatively, multiple different websites/apps) and measure the difference.

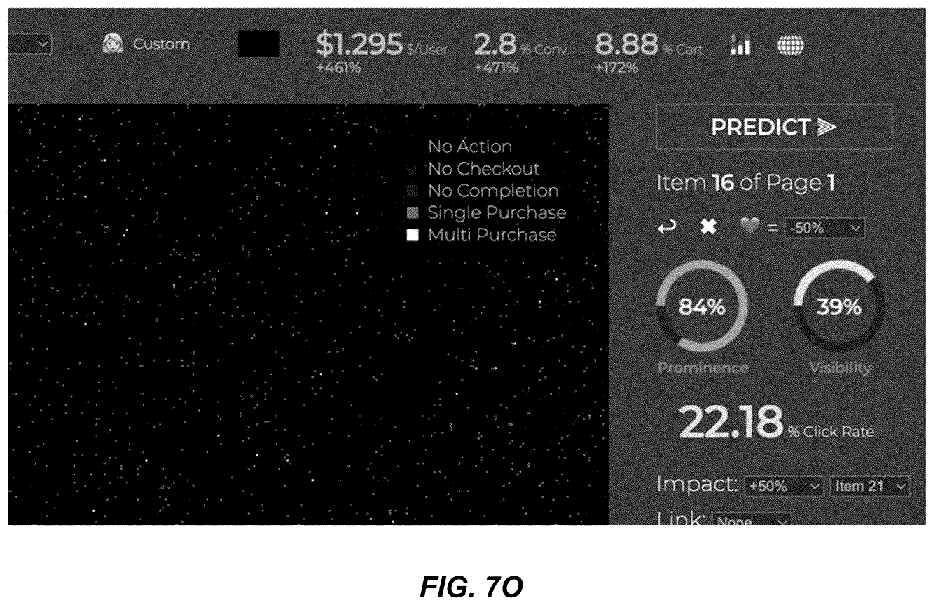

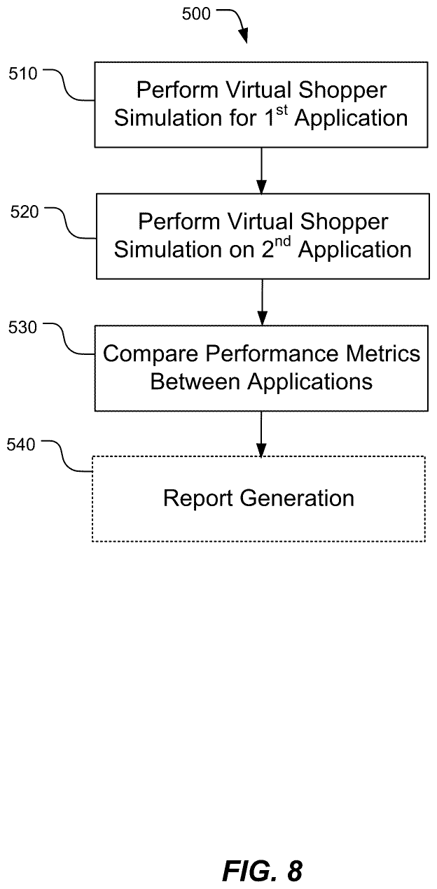

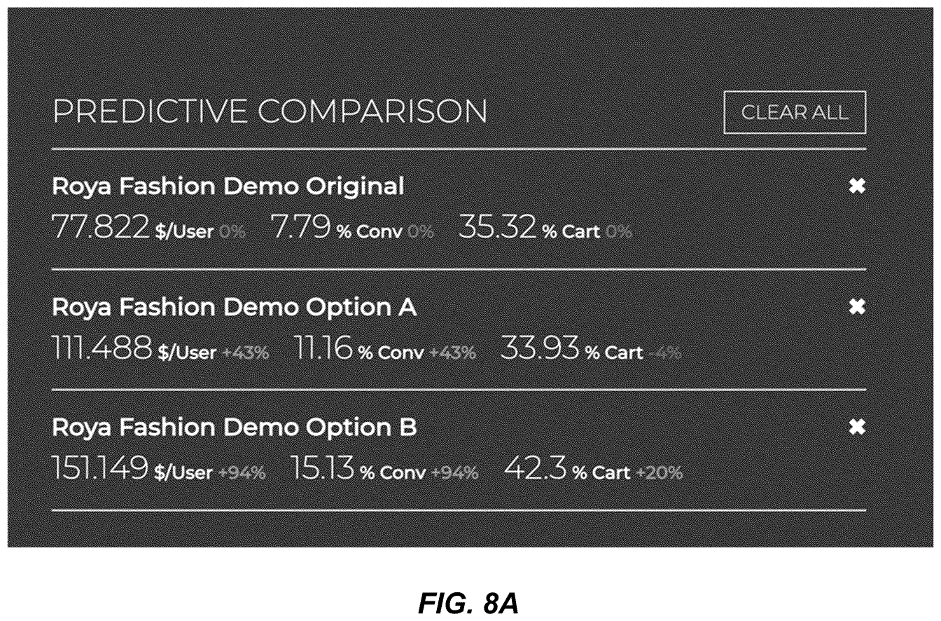

FIG. 8 depicts a method 500 of conducting comparative analysis. In method 500, a simulation on the first baseline site/app is performed and the performance metrics such as revenue per user, conversions, and cart-rate are stored in memory. Then subsequent simulations on other possible sites/apps are performed and their performance metrics are also stored in memory. Then, the metrics of the subsequent sites/apps are compared to the first, providing a means of comparing the relative e-commerce effectiveness of multiple sites/apps. This is useful in comparing possible different app designs/implementations, or, comparing competitive sites/apps. The steps involved in method 500 are described in more detail below with reference to FIG. 8.

Method 500 begins at the first step 510 of performing virtual shopper simulation (as described elsewhere herein) of a first e-commerce website or application, and storing the resulting performance metrics in memory. Following step 510, method 500 proceeds to the second step 520 of performing virtual shopper simulation (as described elsewhere herein) of subsequent e-commerce websites or applications, and storing the resulting performance metrics for each website/application in memory. Following step 520, method 500 proceeds to the third step of comparing the performance metrics of the first website or application to those of the subsequent websites or applications, thereby getting an estimate for the relative change in key metrics between the original site and the subsequent sites. Optionally, method 500 may also comprise a final step 540 of sharing, reporting, and/or displaying the original and subsequent performance metrics in memory. In one embodiment, the comparative analysis results can be displayed by means of a table as shown in FIG. 8A.

In addition to the comparative analysis described above, a wide range of additional applications are possible within the scope of the present invention. Some of these applications are described in more detail below and may be provided by one or more of the embodiments described above, as suited, and without limitation.

### Design-Phase Analysis

In one embodiment, the AI-generated shopper simulation of e-commerce sites/apps can be used during the design phase of the site/app. For example, if a designer is building the site/app in a specific design software, it is possible for the designer to obtain simulated performance metrics with every addition (or alternatively, every series of additions, or every time the designer specifically requests) and keep track of the metrics as the designer is designing the site/app. For example, if the designer adds a button and notices that the revenue/user is $10, then the designer can go and modify the button and observe the differences in the revenue/user metric as she changes the size and placement of the button. This helps guide the designer to build the most optimized website/app.

The key steps in the design-phase utilization of virtual shopper simulation can be described as follows. At the initial step, a designer creates or modifies designs of an e-commerce website/application. At the second step, the designer's creation/modification is used as the basis of a virtual shopper simulation (as described earlier in this document), either automatically within the design studio, or manually by importing the design into the virtual shopper simulation application. At the third step, the performance metrics resulting from virtual shopper simulation are presented to the designer, enabling them to make further modifications to the design while considering the impact of the design changes on the key performance metrics. The third step may be repeated until the designer is satisfied with both the overall design as well as the estimated performance metrics resulting from the virtual shopper simulation.

This process can, for example, allow a designer to make changes to the design until she is happy with the performance metrics of the design. For example, the designer can keep changing a button until the required metrics criterion is achieved. This type of “guided” design that is based on simulated statistical information has the potential to significantly improve and optimize the design process for e-commerce websites and applications.

### User Flow Analysis

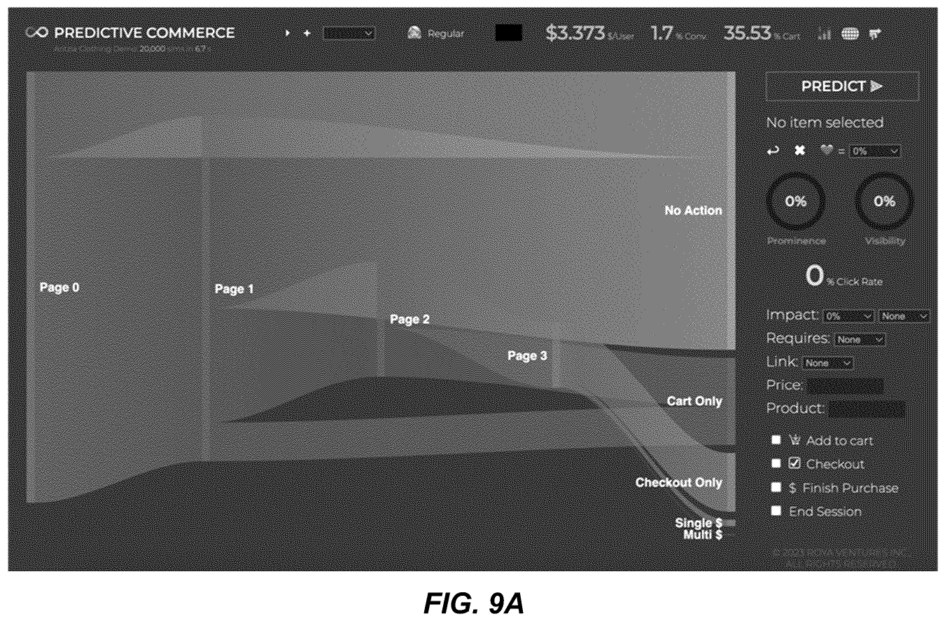

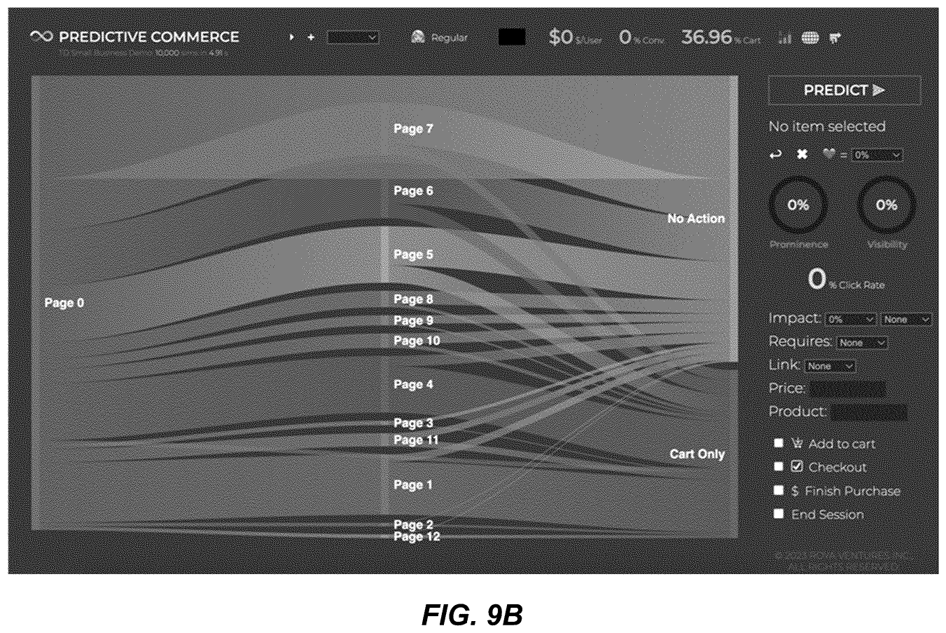

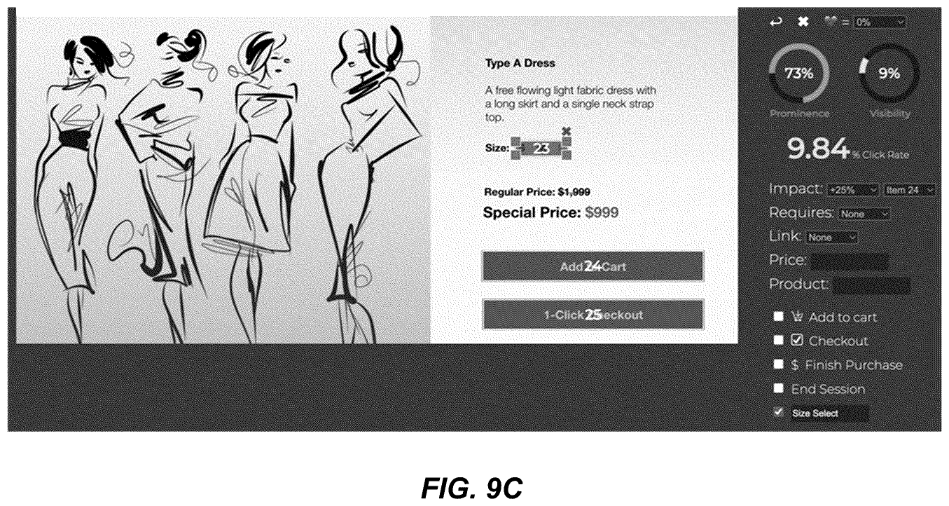

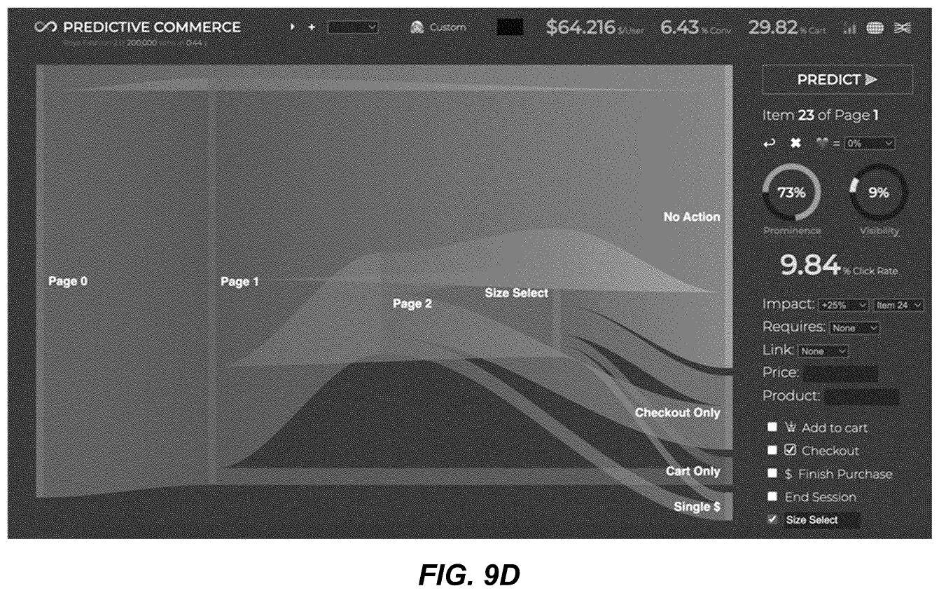

In another embodiment, systems and methods described herein can be applied to analyze the user traffic flow throughout the e-commerce experience by measuring the origin, transition, and destination of the virtual AI shoppers. This can be achieved by storing all origin-destination transition pairs from the virtual AI simulation, including (as examples) but not limited to “Page 0 to Page 1”, “Page 1 to Checkout”, or “Page 2 to Finish $”. Once these transitions are stored for each virtual user and across all virtual AI shoppers, then the user flow analysis can be performed as follows. First, the activity flow of the users from every page or section of the experience to subsequent pages, sections, or actions is counted; second, the total count for each unique transition as a percentage of the total transition list (e.g., “Page 2 to Page 0” accounts for 11% of all transitions) is quantified; and third, a Sankey Diagram or alternative visualization of the user flow through the e-commerce experience is displayed (e.g., by displaying in the visualization the unique transitions weighted by their percentage of occurrence). FIGS. 9A and 9B illustrate two example Sankey diagrams that visualize simulated user flow through each of the respective e-commerce experiences.

### Custom Action Analysis

In yet another embodiment, specific user-selectable actions or options on a website or app may be labeled based on the AI-generated simulation methodology outlined previously, and the simulated AI user flow can be analyzed with respect to the user-selectable actions or options. The first step in this process is to label one or more specific custom actions in the user journey. In the example shown in FIG. 9C, the “Size Select” custom label is created and associated with the size selection element.

Next, the AI simulation is conducted and the specific flow of users at each step of the website journey is measured, including specific pages, custom actions, and end results. In the illustrated example, the “Size Select” custom action (corresponding to the Size Selection element) primarily arises from users on Page 1, and mostly results in either “No Action” or a “Checkout Only” scenario. By observing the AI-simulated user flow, with specific accounting for custom labels and/or custom actions, the overall user journey can be optimized accordingly (e.g., by adjusting a UI element, seeing its impact on a custom action, and readjusting until the desired custom action behaviour/rate is obtained).

Algorithmically, one method of analyzing the custom action labels is to use a two dimensional transition histogram (e.g., a two-dimensional array) which has X and Y indexes for all elements/pages on the site, as well as the outcomes (e.g., Cart, Checkout, Purchase, etc.) and custom actions. First, all elements of the 2D histogram are set to zero. The histogram can then be built based on the outcomes of the AI-generated simulations, meaning that for every user action or transition one element is incremented in the histogram array. For example, if the user progresses from page 2 to page 3, then the histogram array element is incremented with X index of 2 and Y index of 3. If the user who has reached page 2 initiates a custom action, then the histogram element is incremented with X index of 2 and Y index of “Custom Action” where “Custom Action” could be a specific string reference, or a numerical index representation of the Custom Action. After this is done for all users, the result can be displayed by means of a visualization or a table, with one embodiment being the Sankey visualization shown in FIG. 9D.

### Multiversal Training and Analysis

A key component of the systems and methods disclosed herein relates to the method in which user interactions with specific elements of the e-commerce page are probabilistically defined. For example, how does one know what the exact click rate on a particular button or feature will be, or the probability that products are added to cart? In a basic model, outlined above, these elements are each set based on information from analytics applications such as Google Analytics, when available, or they are set based on prior knowledge about the website or general knowledge about typical user interactions. These approaches model users with a single probabilistic network.

An alternative approach would be a multiversal analysis of the app/site users which accounts for the specific user profile and demographics of the particular app/site. The steps in this approach comprise a first step of estimating real click-rate and interaction information and a second step of obtaining the interaction probabilities.

In the first step, human users estimate real click-rate and interaction information for one or more hypothetical users which may be referred to as “Personas”, with each persona having specific demographic specifications including age, gender, salary, and/or any other relevant demographic info. In one embodiment, this human estimation could be done directly via a data entry application. In another embodiment, this estimation could be done by means of a “Prediction” game where different human estimators attempt to estimate interaction rates for the same Persona. Optionally, in order to motivate accurate estimation, human estimators who come closer to the overall average (across all human estimators) can get more points, rewards, and/or prizes.

In the second step, information from the first step can be used as a basis of obtaining interaction probabilities of the Markov Random Field (which was disclosed earlier in this document). In one embodiment, this can be done by averaging all human estimations for the same element and using the average as the actual number for that element's interaction probability. Here, either all of the information (for all Personas) from the first step can be used to build the probability models, or, a subset or weighted portion is used to build the probability model.

As an example, assume 100 personas with human estimated interaction probabilities, of which 50 are male, and 50 are female. As possible examples, for a specific button, the click rate can be computed by one or more of: (a) averaging the human-estimated click rates of all 100 Personas, (b) averaging the click-rates for the 50 female Personas, and (c) performing a weighted average of all 100 Personas with a weight of 1 for the female Personas, and a weight of 0.1 for the male Personas. Approach (a) provides the basis for interaction with the element for all male and female Personas. Approach (b) uses an interaction rate that is based on data from only female Personas. Approach (c) primarily uses data from female Personas, with a small weight attributed to male Personas. The exact approach taken can be changed prior to running the simulation based on a specific demographic target. For example, the simulation can be run for male and separately for female users and e-commerce performance differences can be compared.

The same methodology could be performed either separately or concurrently for other demographic parameters such as gender, salary/income, or any other demographic specification that is relevant to a particular e-commerce experience.

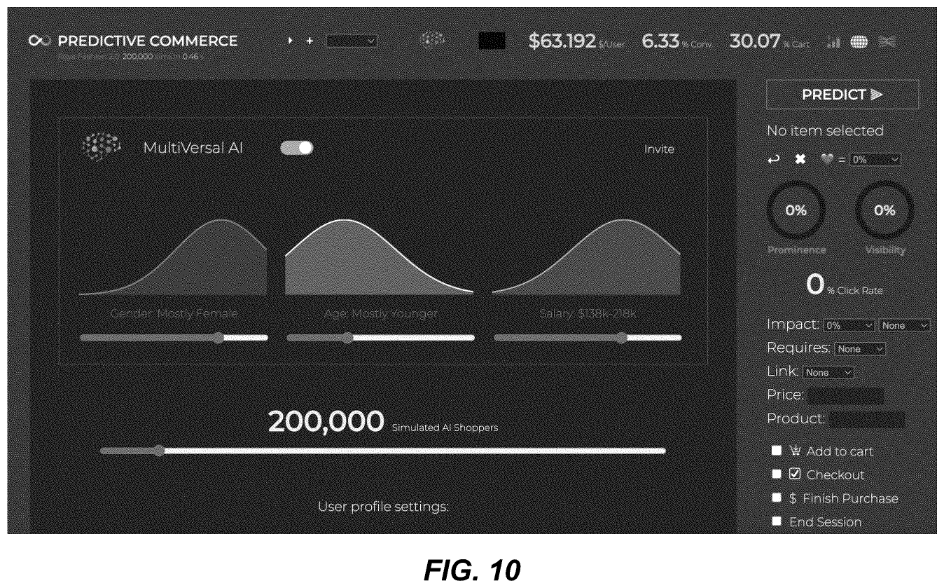

In one embodiment, a user interface is provided as part of the simulation that enables the specific multiversal analysis details (such as gender, age, and salary) to be entered prior to running the simulation, as shown in FIG. 10. More generally, multiversal analysis can be used for any general machine learning system or system that employs training data. By providing a specific training weight for each training data, it becomes possible to “bias” the overall system to be more tuned to a particular demographic. For example, the system can be biased by weighting training data for older users with a higher training weight, resulting in a system that is more in tune and representative of older users. Then, the results of a multiversal analysis can be compared for one demographic with another demographic (e.g. male vs. female, old vs. young, etc.), while noting differences in performance. Such an approach is useful for both building customized machine learning systems that are more personalized and optimized for a particular user demographic, as well as for finding and measuring performance biases of a system for different demographics. For example, the machine learning system could be trained with higher weights for training data attributed to older users, and then that performance could be compared with a system trained on data attributed to all users and compare any performance differences which would be indicative of a potential bias in the overall system against older users.

The examples and corresponding diagrams used herein are for illustrative purposes only. Different configurations and terminology can be used without departing from the principles expressed herein.

Although the invention has been described with reference to certain specific embodiments, various modifications thereof will be apparent to those skilled in the art without departing from the scope of the invention. The scope of the claims should not be limited by the illustrative embodiments set forth in the examples, but should be given the broadest interpretation consistent with the description as a whole. For example, various features are described herein as being present in “some embodiments” or in “one embodiment”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

1. A computer-implemented method for simulating interactions between a human user and an application, the method comprising:
creating a model of a virtual user, wherein the model is defined by a plurality of user intent parameters, each user intent parameter representing an intention of the virtual user to perform a corresponding one of a plurality of actions in the application;
performing a simulation of the virtual user's experience by executing a sequence of actions in the application based on values assigned to the user intent parameters;
measuring statistically relevant information wherein the statistically relevant information comprises one or more of: conversion, sales, and cart rate; and
reporting the statistically relevant information.

2. The method of claim 1, comprising assigning values to the user intent parameters in accordance with a probabilistic network.

3. The method of claim 2, wherein the probabilistic network models a probability of specific actions at multiple points of the virtual user's experience with the application.

4. The method of claim 1, wherein the model is designed to account for progression in time of the virtual user as the virtual user navigates through different parts of the application.

5. The method of claim 1, wherein the user intent parameters comprise an exit probability corresponding to the virtual user's intention to leave the experience.

6. The method of claim 1, wherein the user intent parameters comprise a modified intention probability adjusted for the experience's emotional impact on the virtual user.

7. The method of claim 1, comprising recording results of the simulation.

8. The method of claim 1, comprising analyzing the recorded results to identify a percentage of successful outcomes in the simulation.

9. The method of claim 1, comprising modeling options of the virtual user's experience on the application using a probabilistic network.

10. The method of claim 9, wherein the probabilistic network comprises one or more of a Markov chain, a Markov network, and a Markov Random Field.

11. The method of claim 1, wherein the application is an e-commerce application.

12. A computer-implemented method for simulating a user experience on an e-commerce application comprising:
identifying user options provided by the e-commerce application;
generating a probabilistic network having nodes corresponding to the identified options and edges defining transition dependencies between the identified options;
assigning transition probabilities to the edges based on details of the identified options;
associating at least one of the nodes with an action step; and
traversing through the probabilistic network based on the transition probabilities and the action steps to simulate the user experience on the e-commerce application.

13. The method of claim 12, comprising repeating the step of traversing through the probabilistic network and measuring aggregate simulation performance results.

14. The method of claim 12, dynamically updating the transition probabilities during the traversal through the probabilistic network.

15. The method of claim 12, wherein the details of the identified options comprise one or more of: option visibility, option prominence, and emotional context associated with the option.

16. The method of claim 12, wherein the action steps comprise one or more of adding a product to cart and completing a checkout.

17. The method of claim 12, wherein the probabilistic network is a three-dimensional Markov network.

18. The method of claim 17, wherein edges connecting nodes in first and second dimensions correspond to dependencies between user options in a first page of the e-commerce application, and edges connecting nodes in a third dimension with nodes in the first or second dimensions correspond to dependencies between user options across multiple pages of the e-commerce application.

19. A computer-implemented method for conducting multiversal training of a machine learning system, the method comprising:
obtaining an intended demographic focus for the machine learning system;
obtaining demographic information for each of a plurality of training data elements; and
training the machine learning system based on weighting the plurality of training data elements based on the demographic information and the intended demographic focus.

20. The method of claim 12, wherein assigning transition probabilities to the edges comprises conducting multiversal training in accordance with a computer-implemented method for conducting multiversal training of a machine learning system, the method comprising:
obtaining an intended demographic focus for the machine learning system;
obtaining demographic information for each of a plurality of training data elements; and
training the machine learning system based on weighting the plurality of training data elements based on the demographic information and the intended demographic focus.
